(19) United States
(12) Patent Application Publication
(10) Pub. No.: US 2007/0233465 A1
(43) Pub. Date: Oct. 4, 2007

(54) INFORMATION EXTRACTING APPARATUS, AND INFORMATION EXTRACTING METHOD

(76) Inventors: Nahoko Sato, Kanagawa (JP); Tetsuro Nagatsuka, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/687,852

(22) Filed: Mar. 19, 2007

(30) Foreign Application Priority Data
Mar. 20, 2006 (JP) 2006-077740
Feb. 19, 2007 (JP) 2007-038235

(51) Int. Cl. G06F 17/21

(52) U.S. Cl. 704/10; 704/9

(57) ABSTRACT

The information extracting apparatus includes an analyzer, an element extracting unit, and a supplementary-information obtaining unit. The analyzer analyzes text in input data. The supplementary-information obtaining unit obtains accompanying information such as property information that accompanies the data. The element extracting unit supplements the analysis result with the accompanying information, and extracts information on five elements, When, Where, Who, What and How, and predicate information from the text.

### CROSS-REFERENCE TO RELATED APPLICATIONS

The present document incorporates by reference the entire contents of Japanese priority documents, 2006-077740 filed in Japan on Mar. 20, 2006 and 2007-038235 filed in Japan on Feb. 19, 2007.

### BACKGROUND OF THE INVENTION

1. Field of the Invention

The present invention relates to an information extracting apparatus, and an information extracting method for extracting five element information and predicate information from text information.

2. Description of the Related Art

Currently, because of circulation of a large amount of electronic document data, there are increasing demands for easier methods of managing and reusing collected or accumulated documents. Document analysis technologies such as document search and document classification have been proposed to reuse information. To analyze a document, there is a need of a technology for efficiently extracting useful information from the document to store and output the useful information in an easily usable mode.

A method of extracting a key word, which is a word characterizing a document, is currently the most well-known method among information extracting techniques. For example, Japanese Patent Application Laid-open No. H8-30627 discloses a technology in which frequency of appearance of a word in a document is calculated, and the frequency is converted to a “weight” of the word to automatically identify and extract a key word.

Japanese Patent Application Laid-open No. 2001-84250 discloses a technology in which a target document is modified and analyzed, and the result is stored in a syntax tree format or a linear list, to automatically extract a frequently appeared pattern of words and positions as useful information.

Japanese Patent Application Laid-open No. 2001-75959 discloses a method of registering a name-specific or company name-specific expression pattern in advance and extracting the information by pattern matching has also been proposed.

Japanese Patent Application Laid-open No. 2004-355404 discloses a technology for extracting event information in which achievements of a person are described using a predetermined extraction pattern from a plurality of documents, to arrange and output the achievement of the person.

However, the conventional technologies described in Japanese Patent Application Laid-open Nos. H08-30627 and 2001-84250 are information extracting methods using frequently appearing information of surface information. Therefore, although contents of a text can be analogized from highly frequent information in the text, because accompanying information of an event such as date, period, and place rarely appears frequently in the same text, these pieces of information cannot be easily obtained.

The conventional technologies described in Japanese Patent Application Laid-open Nos. 2001-75979 and 2004-355404 are information extracting methods using a pattern matching method. Therefore, when accompanying expression patterns of events are pre-registered, pattern matching can correspond to various types of expression extraction. However, there is a problem that extraction is difficult if the expression does not match any registered patterns.

### SUMMARY OF THE INVENTION

It is an object of the present invention to at least partially solve the problems in the conventional technology.

According to an aspect of the present invention, an information extracting apparatus includes an analyzer that analyzes a syntactic structure of text information contained in first data, and an extracting unit that extracts information on five elements, When, Where, Who, What and How, and a predicate from the text information based on the syntactic structure.

According to another aspect of the present invention, an information extracting method includes analyzing a syntactic structure of text information contained in first data, and extracting information on five elements, When, Where, Who, What and How, and a predicate from the text information based on the syntactic structure.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an information extracting apparatus according to a first embodiment of the present invention;

FIG. 2 is an example of a description in a knowledge dictionary shown in FIG. 1;

FIG. 3 is an example of 4W1H-plus-predicate information extracted by an element extracting unit shown in FIG. 1;

FIG. 4 is a schematic for explaining an example in which a supplementary-information obtaining unit shown in FIG. 1 supplements the 4W1H-plus-predicate information from attribute information;

FIG. 5 is a schematic for explaining a definition of document;

FIG. 6 is a schematic for explaining an example in which the supplementary-information obtaining unit extracts information from other parts of text for information supplement;

FIG. 7 is a schematic for explaining an example in which the supplementary-information obtaining unit extracts information from other parts of the text and a document property for information supplement;

FIG. 8 is an output example of each extracted data shown in FIGS. 3, 4, 6, and 7;

FIG. 9 is a flowchart of a 4W1H-plus-predicate information extraction process according to the first embodiment;

FIG. 10 is a flowchart of an analysis process;

FIG. 11 is another flowchart of the 4W1H-plus-predicate information extraction process;

FIG. 12 is a functional block diagram of an information extracting apparatus according to a second embodiment of the present invention;

FIG. 13 is a schematic for explaining conversion examples in which an obtained extraction element is converted into an RDF/XML syntax and an RDF graph by a converter shown in FIG. 12;

FIG. 14 is a functional block diagram of an information extracting apparatus according to a third embodiment of the present invention;

FIG. 15 is a schematic for explaining a document-relationship specifying rule applied to specify an inter-document relationship by a document-relationship specifying unit shown in FIG. 14;

FIG. 16 is another example of a description in the knowledge dictionary shown in FIG. 14;

FIG. 17 is a schematic for explaining extraction of an inter-document relationship in an email document group by the information extracting apparatus shown in FIG. 14;

FIG. 18 is a schematic for explaining extraction of 4W1H-plus-predicate information from a document B shown in FIG. 17;

FIG. 19 is a schematic for explaining extraction of 4W1H-plus-predicate information from documents B and C shown in FIG. 17;

FIG. 20 is a schematic for explaining reconstruction of elements from documents A, B, and C in FIG. 17 by an element reconstructing unit shown in FIG. 14;

FIG. 21 is a flowchart of an information extraction process according to the third embodiment;

FIG. 22 is a flowchart of a document relationship-specifying process;

FIG. 23 is a flowchart of a process in which the element reconstructing unit reconstructs 4W1H-plus-predicate information;

FIG. 24 is a schematic for explaining conversion examples in which 4W1H-plus-predicate information is converted into an RDF syntax and an RDF graph by a converter of an information extracting apparatus according to a fourth embodiment of the present invention;

FIG. 25 is a block diagram of a hardware configuration of the information extracting apparatus according to the embodiments;

FIG. 26 is still another example of a description in the knowledge dictionary;

FIG. 27 is an example of 4W1H-plus-predicate information extracted from an English sentence;

FIG. 28 is an example of a document property;

FIG. 29 is a schematic for explaining an example in which the supplementary-information obtaining unit extracts information from the document property for information supplement; and

FIG. 30 is an output example of each data extracted from Example 1 and Example 2 shown in FIGS. 27 and 29.

### DETAILED DESCRIPTION OF THE PREFERRED EMBODIMENTS

Exemplary embodiments of the present invention are explained in detail below with reference to the accompanying drawings.

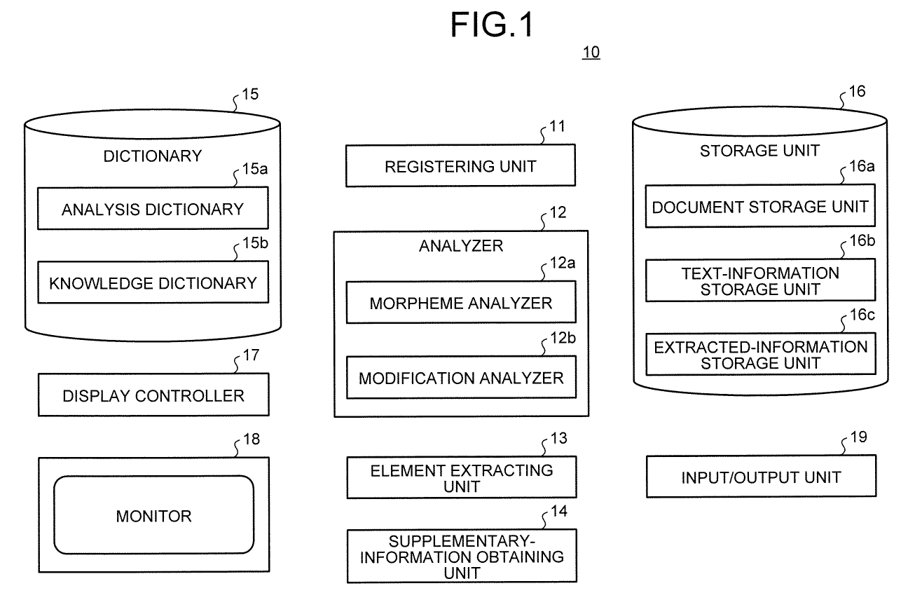

FIG. 1 is a functional block diagram of an information extracting apparatus 10 according to a first embodiment of the present invention. The information extracting apparatus 10 performs an analysis process, an element extraction process, and a supplementary information process relative to input document information, to extract 4W1H-plus-predicate information included in the document information. Incidentally, document information or document as used herein includes any information that contains text.

Specifically, at the time of performing analysis of text part on input document information to extract information of five elements: When, Where, Who, What, and How, that is, 4W1H information as well as predicate information, the information extracting apparatus 10 obtains accompanying information such as property accompanying a document, to supplement the 4W1H information. Thus, by obtaining the accompanying information to supplement the information from the text part, 4W1H and predicate information more accurate than the 4W1H and predicate information that can be extracted only from the text part can be extracted. The 4W1H and predicate information can be used for sentence information to be generated as a sentence or display information to be displayed as a graph. In the explanation below, five element information of When, Where, Who, What, and How and the predicate information are simply referred to as 4W1H-plus-predicate information.

The information extracting apparatus 10 includes a registering unit 11, an analyzer 12, an element extracting unit 13, a supplementary-information obtaining unit 14, a dictionary 15, a storage unit 16, a display controller 17, a monitor 18, and an input/output unit 19.

The analyzer 12 includes a morpheme analyzer 12a and a modification analyzer 12b. The dictionary includes an analysis dictionary 15a and a knowledge dictionary 15b. The storage unit 16 includes a document storage unit 16a, a text-information storage unit 16b, and an extracted-information storage unit 16c.

The registering unit 11 performs document registration process relative to document information input from the input/output unit 19, upon reception of a start command of the element extraction process, and sequentially stores the registered information extraction-target documents in the document storage unit 16a.

The analyzer 12 performs analysis process relative to the text part in the document information stored in the document storage unit 16a for each document. At the time of performing analysis, the analyzer 12 refers to the analysis dictionary 15a. Regarding the analysis process, the morpheme analyzer 12a performs a morpheme analysis process, and the modification analyzer 12b performs a modification analysis process. The process is performed herein for the text part in the document information, and the text part is simply referred to as text.

The morpheme analyzer 12a divides the text into each word, and performs a morpheme analysis process to add an attribute of each word. Existing methods such as a longest-match method, a lowest-cost method, and an example-search method can be applied to the morpheme analysis performed by the morpheme analyzer 12a. Reference may be had to “Chapter 4, Morpheme analysis” in “Japanese information processing”, which is incorporated herein by reference.

The modification analyzer 12b creates a clause of one independent word or a clause in a format in which at least one adjunct is added to one independent word, and performs a modification analysis process for identifying in what kind of relationship respective clauses are.

For example, in a sentence [symbol] [symbol] (The apple I ate), because [symbol] (I) is grammatically in a modification relationship with a declinable clause [symbol] (ate), and modifies the declinable clause, the modification analyzer 12b identifies that a modification relationship thereof is “ga-case continuous modification relationship”.

Further, because the declinable clause [symbol] is grammatically in a modification relationship with an indeclinable clause [symbol] (The apple), and modifies the indeclinable clause, the modification analyzer 12b identifies that a modification relationship name thereof is “adnominal form relationship”. For the modification analysis process performed by the modification analyzer 12b, existing methods can be used. Reference may be had to “Chapter 5, Syntax analysis” in “Japanese information processing”, which is incorporated herein by reference.

Upon completion of a text-information obtaining process for one document, the modification analyzer 12b sequentially stores the result thereof in the text-information storage unit 16b. Upon completion of the text-information obtaining process for all of the registered documents by the modification analyzer 12b, the element extracting unit 13 executes the element extraction process relative to the stored language information.

The element extracting unit 13 extracts information specifying 4W1H corresponding to period, place, subject, object, and mode (When, Where, Who, What, and How) and predicate, that is, 4W1H-plus-predicate information for each sentence in one document. As the 4W1H-plus-predicate information, information of 4W1H and predicate cannot be always obtained, derived from an original text.

The knowledge dictionary 15b describing knowledge, which uses grammar characteristic, is used for information extraction performed by the element extracting unit 13. When the element extracting unit 13 finishes extraction of one sentence, the extracted element is stored in the extracted-information storage unit 16c. The element extracting unit 13 then executes the element extraction process from the language information of the next sentence and storage.

Upon completion of the element extraction process and storage relative to all sentences in the text part in content information of one document, the element extracting unit 13 executes similar element extraction process and storage from the first sentence in the text part in content information of the next document.

Upon completion of the element extraction process and storage relative to all the registered documents and upon reception of an output command, the display controller 17 displays the stored extracted information on the monitor 18. The element extracting unit 13 finishes the element extraction process, upon reception of an end command.

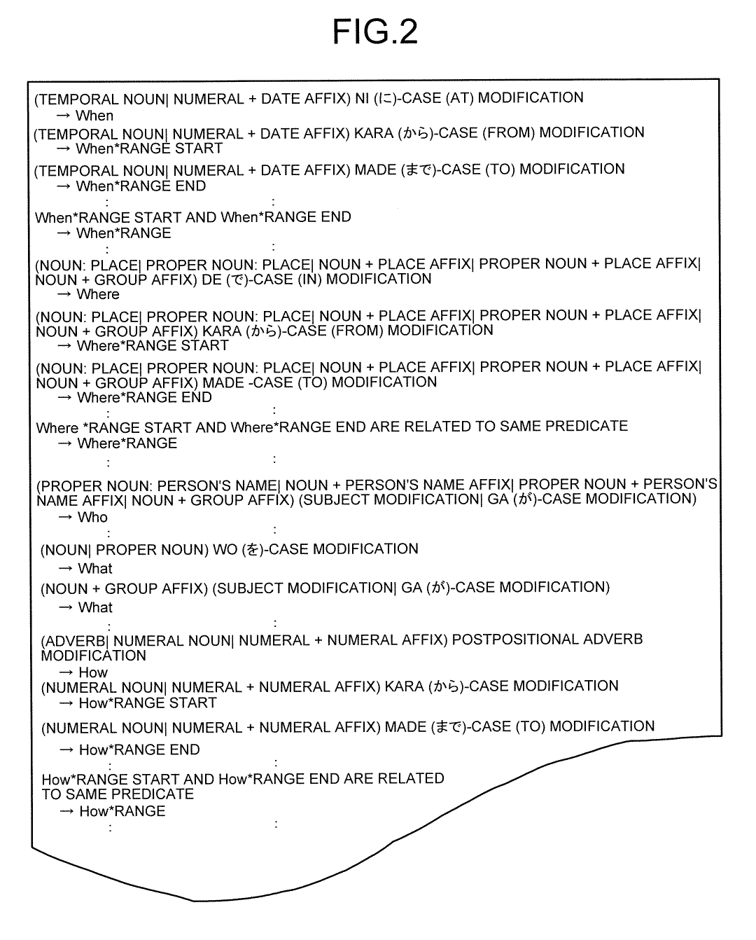

FIG. 2 is an example of a description in the knowledge dictionary 15b. The knowledge dictionary 15b describes specific parts-of-speech information of words belonging to a clause or combinations of pieces of specific parts-of-speech information, relationship information between a modification destination of the clause and modification, and semantic interpretation thereof indicating which of 4W1H (When, Where, Who, What, and How) the clause belongs to. As shown in FIG. 2, a concise description can be made by adopting a description format by regular expression, when there is a plurality of pieces of specific parts-of-speech information, or relative to the combination thereof. As constituent elements of the dictionary, a semantic attribute can be added to the semantic interpretation of 4W1H. In FIG. 2, detailed semantic attributes such as “start of range”, “end point of range”, and “range” are given to the When information and Where information.

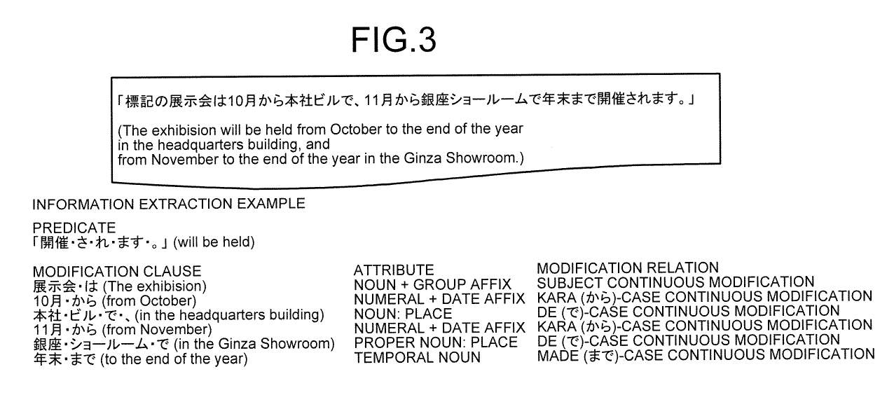

FIG. 3 is an example of 4W1H-plus-predicate information extracted by the element extracting unit 13. A predicate, a clause having a direct modification relationship therewith, clause attribute, and modification relationship are extracted from a text example of

[symbol]

[symbol]

[symbol]

[symbol]

[symbol]

[symbol]

[symbol]

### (The exhibition will be held from October to the end of the year in the headquarters building, and from November to the end of the year in the Ginza Showroom.) as an example of extraction of the 4W1H-plus-predicate information.

The supplementary-information obtaining unit 14 obtains attribute information accompanying the document to supplement extraction of the 4W1H-plus-predicate information based on the obtained attribute information. The attribute information is peripheral information of the document, other than the content information directly described in the document.

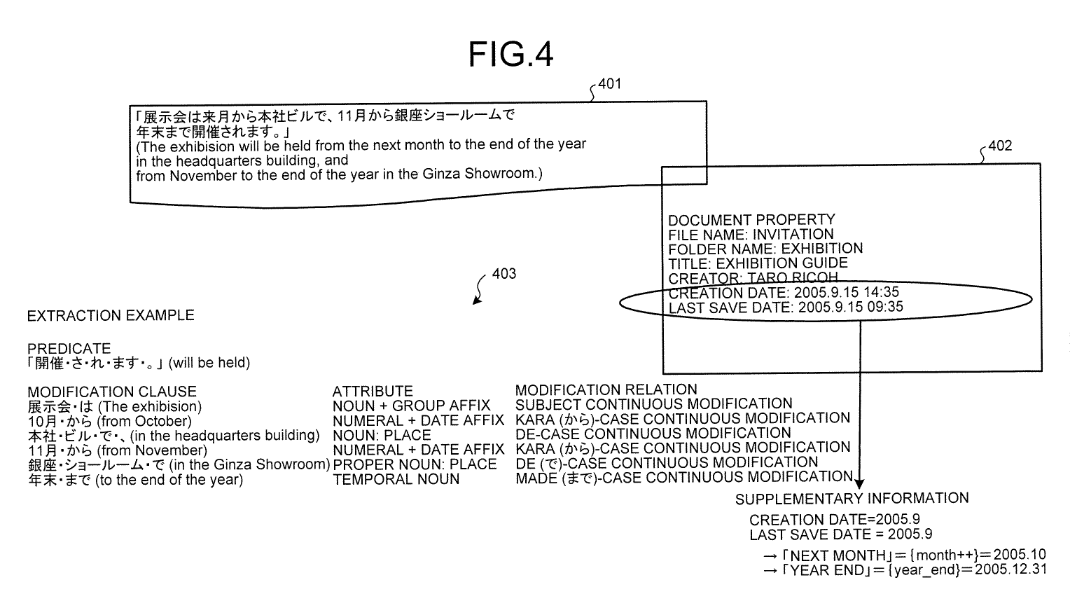

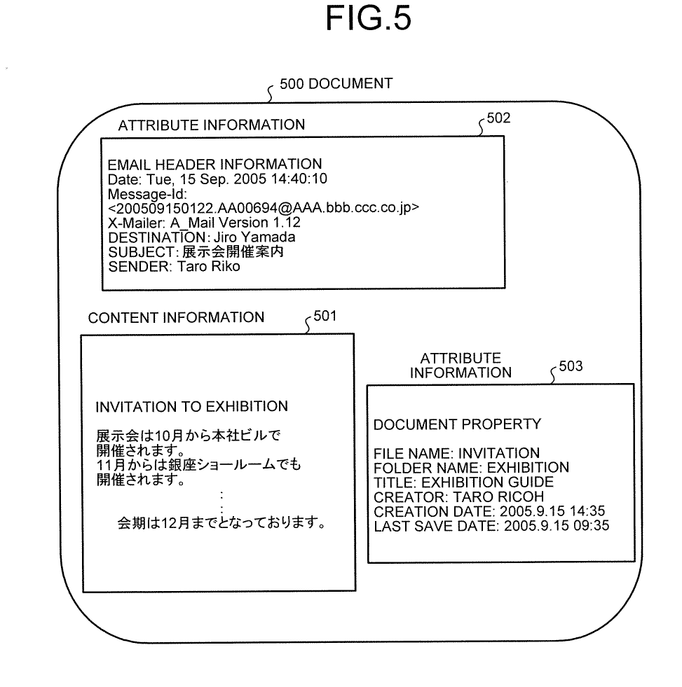

FIG. 4 is a schematic for explaining an example in which the supplementary-information obtaining unit 14 supplements extraction of the 4W1H-plus-predicate information from the attribute information. FIG. 5 is a schematic for explaining a definition of the document.

The document is formed of the content information and the attribute information. The content information is a part directly included in the described document content, and includes, for example, a text part 401 (FIG. 4), an image part, and a graph part. The attribute information is information automatically added by a used application, and for example, information of document property 402 (FIG. 4), and bibliographical information is a representative example thereof). In FIG. 5, a document 500 includes content information 501, and attribute information 502 and 503.

For example, following information is included as document properties of a certain software product (that is, file name, current folder name, template, title, sub-title, creator, key word, explanation, creation date, number of changes, last save date, and last saving person).

In the case of an email document, the content information 501 is the text of the email. The supplementary-information obtaining unit 14 obtains header information as the attribute information 502, in which transmitter's information, transmission route information, and used email software information are described, and a footer as the attribute information. If possible, related information obtained other than the content information of the target document, such as used application information, created place information, and created equipment information is handled as the attribute information.

Document property 402 shown in FIG. 4 is automatically added at the time of document registration, and is used as the attribute information. In this example, the supplementary-information obtaining unit 14 calculates specific date such as [symbol] (this month) or [symbol] (end of the year) in the text from the creation date and the last save date of document property 402, and obtains the specific date as the supplementary information. Additionally, if equipment information, application information, and place information can be obtained, these pieces of information are used as the attribute information for supplementing information. Extraction example 403 shows an example supplemented and extracted by the supplementary-information obtaining unit 14 relative to the text part 401, based on the information of document property 402.

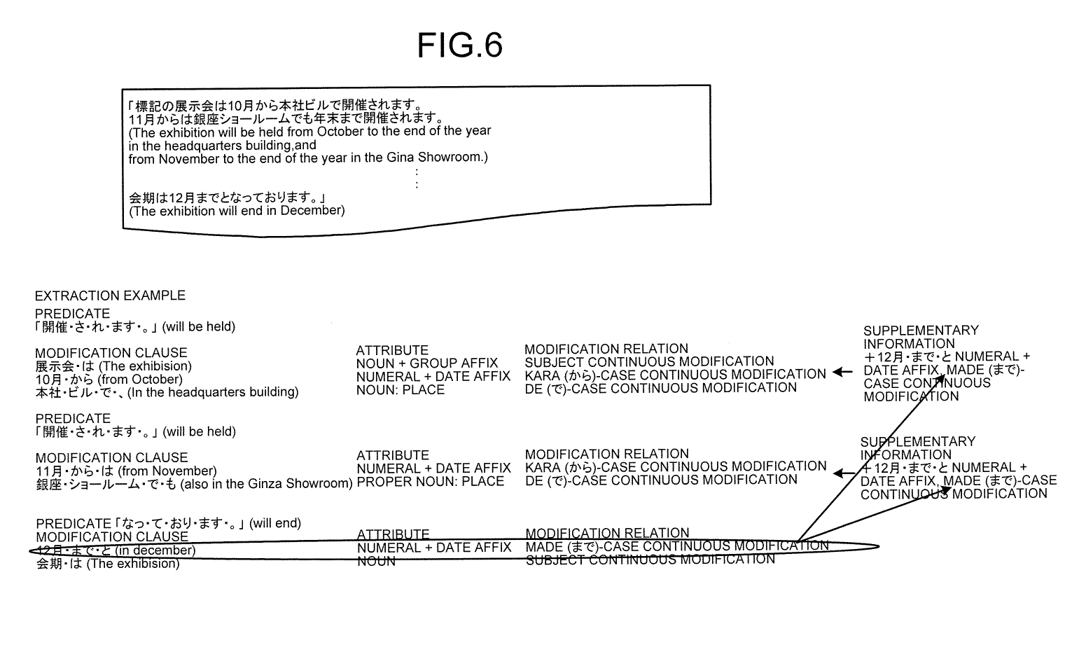

FIG. 6 is a schematic for explaining an example in which the supplementary-information obtaining unit 14 extracts information from other parts of the text for information supplement. Only 10 [symbol] (October) and 11 [symbol] (November) as a start of exhibition can be extracted from the first and the second sentences in the text. However, by using a made-case modification clause in a subsequent sentence, supplementary information as the range end point can be added to the extracted information from the first and the second sentences.

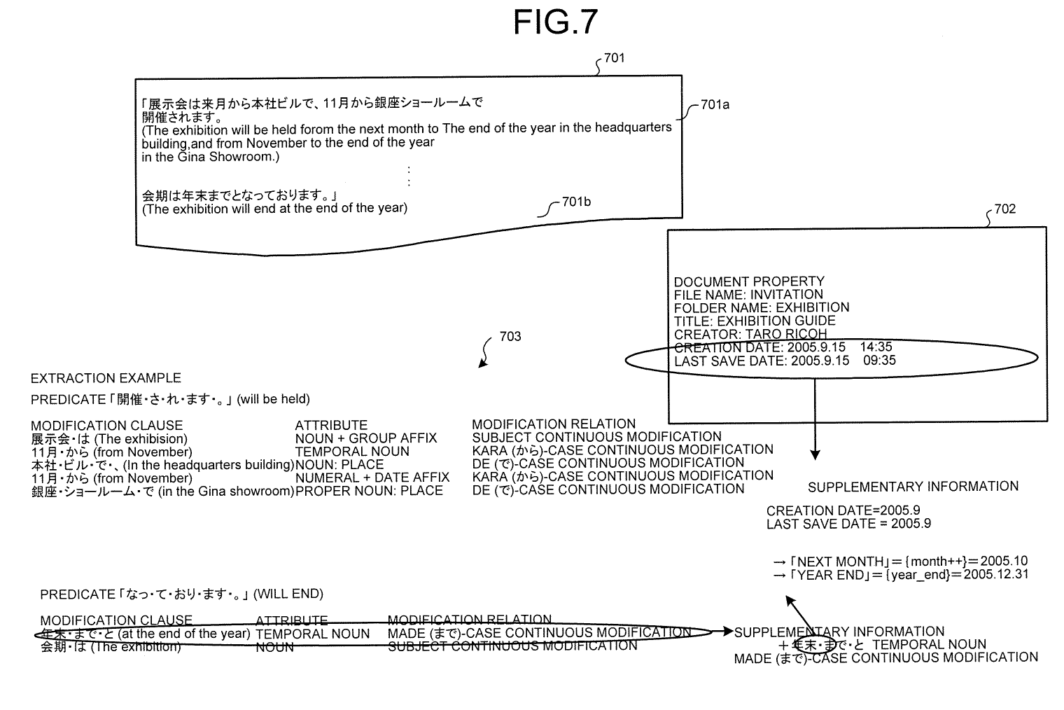

FIG. 7 is a schematic for explaining an example in which the supplementary-information obtaining unit 14 extracts information from other parts of the text and the document property for information supplement. Extraction example 703 is extracted from a relevant sentence 701a in text 701, and temporal range information is obtained in more detail from another part 701b in the text and document property 702. That is, information of October as the next month and information of December 31st as the end of the year are obtained.

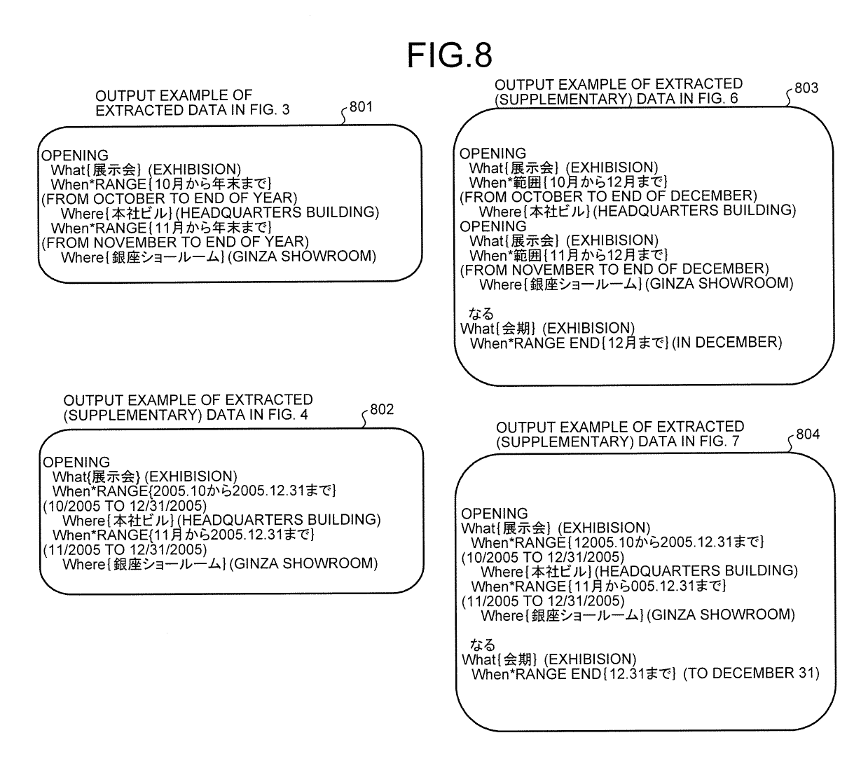

FIG. 8 depicts an output example 801 of extracted data in FIG. 3, an output example 802 of extracted data in FIG. 4, an output example 803 of extracted data in FIG. 6, and an output example 804 of extracted data in FIG. 7.

The analysis process of the information extracting apparatus 10 is explained below, with reference to FIGS. 2, 3, and 8. It is assumed herein that the information extracting apparatus 10 is started up, and the registering unit 11 registers a text including a sentence

[symbol]

[symbol]

[symbol]

[symbol]

[symbol]

[symbol]

[symbol]

as shown in FIG. 3. In the information extracting apparatus 10, the document storage unit 16a stores therein the registered document, and the analyzer 12 performs the analysis process.

The analyzer 12 picks up one sentence from the head of the document, and the morpheme analyzer 12a performs the morpheme analysis process by referring to the analysis dictionary. An example of a result of the morpheme analysis process performed by the morpheme analyzer 12a is shown below. Writing of words constituting the document and parts of speech are stored in a pair. In this case, other word attributes can be expressed as accompanying information.

( [symbol] noun)

( [symbol] case particle ‘no’)

( [symbol] noun)

( [symbol] affix: group)

( [symbol] postpositional adverb)

(10 numeral)

( [symbol] affix: date)

( [symbol] case particle ‘kara’)

( [symbol] noun)

( [symbol] noun: place)

( [symbol] case particle ‘de’)

(11 numeral)

( [symbol] affix: date)

( [symbol] case particle ‘kara’)

( [symbol] proper noun: place)

( [symbol] noun: place)

( [symbol] case particle ‘de’)

( [symbol] temporal noun)

( [symbol] case particle ‘made’)

( [symbol] sahen noun)

( [symbol] verbal auxiliary)

( [symbol] auxiliary verb)

( [symbol] auxiliary verb)

(α punctuation)

The modification analyzer 12b refers to the analysis dictionary 15a to perform the modification analysis process based on the morpheme analysis result. An example of a result of the modification analysis process according to the first embodiment is as follows:

| | | | | Modification |
|---|---|---|---|---|
| No. | Clause writing | Attribute | Modification | destination |
| 0 | [symbol] | Noun | ‘no’ adnominal | 1 |
| | | | form | |
| 1 | [symbol] | Noun + group affix | Subject continuous | 7 |
| | | | modification | |
| 2 | [symbol] | Numeral + date affix | kara-case continuous | 7 |
| | | | modification | |
| 3 | [symbol] | Noun: place | de-case continuous | 7 |
| | | | modification | |
| 4 | [symbol] | Numeral + date affix | kara-case continuous | 7 |
| | | | modification | |
| 5 | [symbol] | Proper noun: place | de-case continuous | 7 |
| | | | modification | |
| 6 | [symbol] | Temporal noun | made-case continuous | 7 |
| | | | modification | |
| 7 | [symbol] | Sahen noun + verbal | End of sentence | −1 |
| | | auxiliary + auxiliary verb + punctuation | | |

Upon completion of the modification analysis process for one sentence, the analysis result is stored in the text-information storage unit 16b.

When there is the next sentence in the registered text, the process control returns to the start of the morpheme analysis process, to execute the morpheme analysis and modification analysis relative to the next sentence. This operation is performed relative to all sentences in the text. Upon completion of the analysis process for all sentences, control proceeds to the element extraction process performed by the element extracting unit 15.

### (Element Extraction Process)

(1) The element extracting unit 13 extracts a result of the analysis process for the first sentence from the text-information storage unit 16b, to search for a declinable word to be defined as predicate or an end-of-sentence clause terminated with a substantive. The last clause is a clause with clause number 7.

(2) Find a predicate [symbol] (will be held) from clause number 7.

(3) Temporarily store writing of

[symbol]

(4) Search for a clause directly continuous-modifying clause number 7 sequentially from clause number 7 toward the first clause of the sentence.

(5) Because a clause number of a modification destination of clause number 6 is “7”, it can be seen that the clause of clause number 6 directly continuous-modifies the predicate [symbol] thereby storing writing and attribute “temporal noun” of [symbol] (to the end of the year), and modification relationship “made-case continuous modification”.

(6) Search for a clause directly continuous-modifying clause number 7 sequentially from clause number 6 toward the first clause.

(7) Because a clause number of a modification destination of clause number 5 is “7”, it can be seen that the clause of clause number 5 directly continuous-modifies the predicate [symbol] , thereby storing writing and attribute “proper noun: place” of [symbol] (in the Ginza showroom), and modification relationship “de-case continuous modification”.

(8) Search for a clause directly continuous-modifying clause number 7 sequentially from clause number 5 toward the first clause.

(9) Because a clause number of a modification destination of clause number 4 is “7”, it can be seen that the clause of clause number 4 directly continuous-modifies the predicate [symbol] thereby storing writing and attribute “numeral+date affix” of 11 [symbol] (from November), and modification relationship “kara-case continuous modification”.

(10) Search for a clause directly continuous-modifying clause number 7 sequentially from clause number 4 toward the first clause.

(11) Because a clause number of a modification destination of clause number 3 is “7”, it can be seen that the clause of clause number 3 directly continuous-modifies the predicate [symbol] , thereby storing writing and attribute “noun: place” of [symbol] (in the headquarters building), and modification relationship “de-case continuous modification”.

(12) Search for a clause directly continuous-modifying clause number 7 sequentially from clause number 3 toward the first clause.

(13) Because a clause number of a modification destination of clause number 2 is “7”, it can be seen that the clause of clause number 2 directly continuous-modifies the predicate [symbol] , thereby storing writing and attribute “numeral+date affix” of 10 [symbol] (from October), and modification relationship “kara-case continuous modification”.

(14) Search for a clause directly continuous-modifying clause number 7 sequentially from clause number 2 toward the first clause.

(15) Because a clause number of a modification destination of clause number 1 is “7”, it can be seen that the clause of clause number 1 directly continuous-modifies the predicate [symbol] , thereby storing writing and attribute “noun+group affix” of [symbol] , and modification relationship “subject continuous modification”.

(16) Search for a clause directly continuous-modifying clause number 7 sequentially from clause number 1 toward the first clause.

(17) Because a clause number of a modification destination of clause number 0 is “1”, it can be seen that the clause of clause number 0 does not directly continuous-modify the predicate [symbol] Because the clause that does not directly continuous-modify the predicate is not an extraction target, the clause [symbol] is not stored.

(18) Upon completion of search up to the first clause, search for a clause directly continuous-modified by clause number 7 toward the last clause of the sentence.

(19) Because there is no such a clause, extraction of related clause elements of predicate [symbol] finishes.

(20) Search for the declinable word defined as predicate or the end-of-sentence clause terminated with a substantive from clause number 6.

(21) Because a predicate is not detected, extraction of predicate in the illustrative sentence finishes. The extraction result is as shown in an information extraction example in FIG. 3.

(22) Collate the extracted and temporarily stored information with the knowledge dictionary 15b in FIG. 2, and if there is information matching with the knowledge dictionary, 4W1H information is specified respectively.

From the description of “(noun+group affix) (subject modification ga-case modification)→What” in the knowledge dictionary, it is specified that [symbol] is “What”. From the description of “(temporal noun|numeral+date affix) kara-case modification→When*range start”, “temporal noun|numeral+date affix) kara-case modification→When*range end”, and “When*range start and*range end are related to the same predicate→When*range”, it is specified that 10 [symbol] is “When*range”. Further, it is specified that 11 [symbol] is “When*range”.

From the description of “(noun: place|proper noun: place|noun+place affix|proper noun+place affix|noun+group affix) de-case modification→Where”, it is specified that [symbol] and [symbol] are “Where”. These pieces of information are stored in the extracted-information storage unit 16c in a unit of 4W1H.

(23) Thus, extraction of predicate and related clause elements, specification of 4W1H, and storage are repeated relative to all sentences in the text.

(24) Upon completion of information extraction relative to all sentences in the text, if there is an output command, execute an output process. An output example of extracted data of the text in FIG. 3 in this case is shown in the output example 801 in FIG. 8.

An example of information supplement process from other text parts is explained with reference to FIGS. 2, 6, and 8. It is assumed herein that the information extracting apparatus 10 is started up, and a text including a sentence

[symbol]

10 [symbol] [symbol] [symbol] α 11 [symbol] [symbol] [symbol] [symbol] . . . ( [symbol] ) . . . [symbol] 2

[symbol]

[symbol]

### (The exhibition will be held from October to the end of the year in the headquarters building, and from November to the end of the year in the Ginza Showroom. . . . (snip) . . . The exhibition will end in December)

as shown in FIG. 6 is registered. The information extracting apparatus 10 stores a registered document in the document storage unit 16a and proceeds to the analysis process.

The analysis process is performed in the same manner as previously described. Upon completion of the analysis process, the same processes as those described in (1) to (24) are performed to obtain an information extraction example in FIG. 6. Thus, 4W1H information is specified and stored.

### (Information Supplement Process)

(1) Check if all pieces of information of 4W1H have been obtained from the first sentence relative to each sentence in the text. From the first sentence in the text in FIG. 8, “What ( [symbol] )”, “When*range start (10 [symbol] )”, and “Where ( [symbol] )” can be obtained.

(2) Recognize information of 4W1H lacking in the sentence. In this example, it is recognized that information of “Who” and “How” is lacking. It is also recognized that although there is information of “When*range start”, there is no information of “When*range end” in the sentence.

(3) If there is information lacking in the 4W1H information, supplementary information is searched sequentially from the next sentence. In this example, there is no information of “Who”, “How”, and “When*range end” in the next sentence, as well.

(4) Check the next sentence and repeat a search for supplementary information.

(5) In the last sentence

┌ [symbol] 12 [symbol] [symbol] ┘ (the exhibition will end in December), it can be seen that there is “When*range end (12 [symbol] )”, and this information is added to the extracted information from the first sentence as supplementary information.

(6) Obtain the supplementary information and re-read the knowledge dictionary shown in FIG. 2.

(7) Because there are information of When*range start and information of When*range end, “When*range (10 [symbol] ) can be obtained.

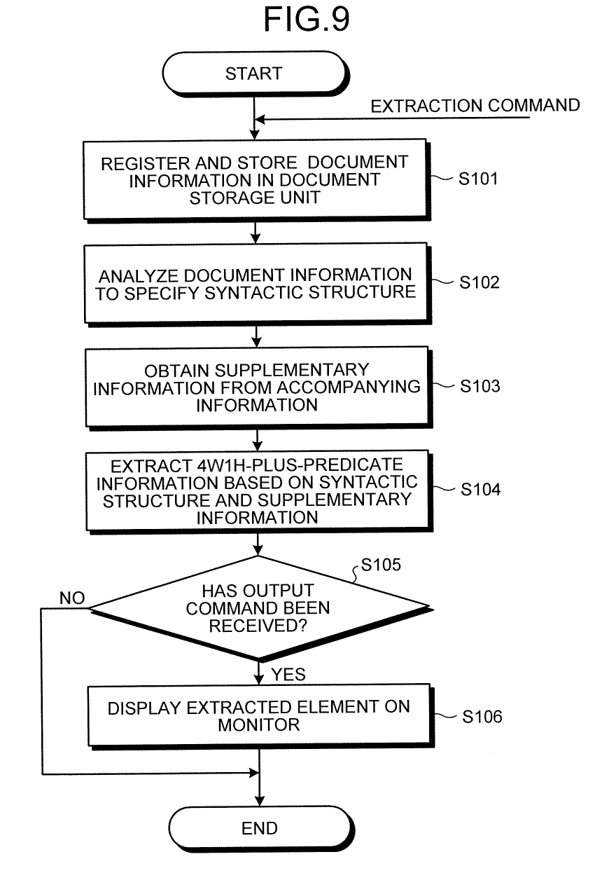

(8) Check if all pieces of information of 4W1H can be obtained relative to the second sentence in FIG. 6. From the second sentence in the text shown in FIG. 9, “What ( [symbol] )”, “When*range start (November)”, and “Where ( [symbol] )” can be obtained.

(9) Recognize information of 4W1H lacking in the sentence. In this example, it is recognized that information of “Who” and “How” is lacking. It is also recognized that although there is information of “When*range start”, there is no information of “When*range end” in the sentence.

(10) Because there is information lacking in the 4W1H information, search for supplementary information sequentially from the next sentence.

(11) Check the next sentence and repeat a search for supplementary information.

(12) In the last sentence in this example,

[symbol]

12 [symbol] [symbol] , it can be seen that there is “When*range end (12 [symbol] )”, and this information is added to the extracted information from the second sentence as supplementary information.

(13) Obtain the supplementary information and re-read the knowledge dictionary shown in FIG. 2.

(14) Because there are information of When*range start and information of When*range end, “When*range (11 [symbol] 2 [symbol] ) can be obtained.

(15) Thus, repeat the following operations, that is, recognize information lacking in the 4W1H information relative to each sentence in the text, check the presence of supplementary information from the next to the last sentences, and if there is the supplementary information, use the supplementary information to supplement the information, and re-read the knowledge dictionary to re-specify the 4W1H information.

(16) Check if all pieces of information of 4W1H can be obtained relative to the last sentence. From the last sentence in the text in FIG. 6, “What ( [symbol] )” and “When*range end (12 [symbol] )” can be obtained.

(17) Recognize information of 4W1H lacking in the sentence. In this example, it is recognized that information of “Who”, “Where”, and “How” is lacking. It is also recognized that although there is information of “When*range end”, there is no information of “When*range start” in the sentence.

(18) Because there is information lacking in the 4W1H information, search for supplementary information sequentially from the next sentence.

(19) Because there is no next sentence, finish the information supplement process.

(20) Upon completion of the information supplement process relative to all sentences in the text, if there is an output command, execute the output process. An output example of extracted data of the text in FIG. 6 in this case is shown in the output example 803 in FIG. 8.

Another example in which 4W1H information is supplemented from the attribute information is explained with reference to FIGS. 2, 4, and 8.

It is assumed herein that when the information extracting apparatus 10 is started up, a text including a sentence

[symbol]

[symbol]

[symbol]

11

[symbol]

[symbol]

[symbol]

[symbol]

### (The exhibition will be held from the next month to the end of the year in the headquarters building, and from November to the end of the year in the Ginza Showroom.)

as shown in FIG. 4 is registered. The information extracting apparatus 10 stores the registered document in the document storage unit 16a and proceeds to the analysis process. The same analysis process as described above is performed. Upon completion of the analysis process, the same processes as explained in (1) to (24) are performed to obtain an information extraction example in FIG. 4. Thus, 4W1H information is specified and stored.

(1) Check if all pieces of information of 4W1H have been obtained from the first sentence relative to each sentence in the text.

(2) From the text in FIG. 4, “What ( [symbol] )”, “When*range start ( [symbol] )”, “Where ( [symbol] )”, “When*range start (11 [symbol] )”, Where ( [symbol] )”, “When*range end ( [symbol] )” can be specified, and stored in the extracted-information storage unit in a unit of 4W1H.

(3) Recognize information of 4W1H lacking in the sentence. In this example, it is recognized that information of “Who” and “How” is lacking.

(4) The document property shown in FIG. 4 is obtained as the attribute information as follows:

File Name: Invitation

Folder Name: Exhibition

Title: Exhibition guide

Creator: Taro Ricoh

Creation Date: 2005.9.15 14:35

Last Save Date: 2005.9.17 09:35

(5) In the attribute information, because information relating to the content of the text is not included, information of “Who” and “How” cannot be obtained.

(6) However, the creation date and the last save date can be obtained, and these pieces of information are compared with When information. When information in this example is “When*range start ( [symbol] )”, “When*range start (11 [symbol] )”, and “When*range end ( [symbol] )”.

(7) At first, it is assumed that “When*range start ( [symbol] )” is the next month based on the creation date of the text in the example, that is, “2005.9.15 14:35”, and month information “September” of the creation date is added to determine that the next month is October. Because the year is the same and date and time are uncertain, “2005.10” is supplemented.

(8) Because specific month is specified in “When*range start (11 [symbol] )”, it is off the subject of information supplement.

(9) It is assumed from “When*range end ( [symbol] ) that it is the end of year 2005 from the text creation date and the last save date, to obtain the year information “2005” from the text creation date and the last save date. Because the end of the year can be specified as December 31st, “2005.12.31” is supplemented as specific date.

(10) Replace the extracted information with the supplementary information, to specify the extracted 4W1H-plus-predicate information as “What ( [symbol] )”, “When*range start (2005.10)”, “Where ( [symbol] )”, “When*range start (11 [symbol] )”, Where ( [symbol] )”, and “When*range end (2005.12.31)”.

(11) Upon completion of the information supplement process relative to all sentences in the text, if there is an output command, execute the output process. An output example of extracted data of the text in FIG. 4 in this case is shown in the output example 802 in FIG. 8.

Another example of information supplement in which information is supplemented by using the other text parts and the attribute information is explained with reference to FIGS. 2, 7, and 8. It is assumed herein that the information extracting apparatus 10 according to the present invention is started up, and a text including a sentence

[symbol]

[symbol]

11 [symbol] [symbol] [symbol] , . . . ( [symbol] ) . . . [symbol] [symbol] [symbol]
as shown in FIG. 7 is registered. The information extracting apparatus 10 stores the registered document in the document storage unit 16a and proceeds to the analysis process. The same analysis process as described above is performed. Upon completion of the analysis process, the same processes as explained in (1) to (24) are performed to obtain an information extraction example in FIG. 7. Thus, 4W1H information is specified and stored.

### (Information Supplement Process)

(1) Check if all pieces of information of 4W1H have been obtained from the first sentence relative to each sentence in the text.

(2) From the text in FIG. 7, “What ( [symbol] )”, “When*range start ( [symbol] )”, “Where ( [symbol] )”, “When*range start (11 [symbol] )”, and Where ( [symbol] )” can be specified, and stored in the extracted-information storage unit in a unit of 4W1H.

(3) Recognize information of 4W1H lacking in the sentence. In this example, it is recognized that information of “Who” and “How” is lacking. It is also recognized that although there is information of “When*range start”, there is no information of “When*range end” in the sentence. If there is any lacking information of the 4W1H information, search for supplementary information sequentially from the next sentence. In this example, the next sentence does not include information of “Who”, “How”, and “When*range end”, as well.

(4) Check the next sentence and repeat search for supplementary information.

(5) In the last sentence

[symbol]

[symbol]

[symbol]

, it can be seen that there is information of “When*range end ( [symbol] )”, and this information is added to the extracted information from the first sentence as the supplementary information.

(6) Obtain the supplementary information and re-read the knowledge dictionary shown in FIG. 2.

(7) Because there are information of When*range start and information of When*range end, “When*range ( [symbol] [symbol] )” and “When*range 11 [symbol] [symbol] ” can be obtained.

(8) Thus, repeat the following operations, that is, recognize information lacking in the 4W1H information relative to each sentence in the text, check the presence of supplementary information from the next to the last sentences, and if there is the supplementary information, use the supplementary information to supplement the information, and re-read the knowledge dictionary to re-specify the 4W1H information.

(9) Check if all pieces of information of 4W1H can be obtained relative to the last sentence. From the last sentence in the text in FIG. 7, “What ( [symbol] )” and “When*range end ( [symbol] )” can be obtained.

(10) Recognize information of 4W1H lacking in the sentence. In this example, it is recognized that information of “Who”, “Where”, and “How” is lacking. It is also recognized that although there is information of “When*range end”, there is no information of “When*range start” in the sentence.

(11) Because there is information lacking in the 4W1H information, search for supplementary information sequentially from the next sentence.

(12) Because there is no next sentence, finish the information supplement process.

(13) Document property 702 shown in FIG. 7 is obtained as the attribute information as follows:

File Name: Invitation

Folder Name: Exhibition

Title: Exhibition guide

Creator: Taro Ricoh

Creation Date: 2005.9.15 14:35

Last Save Date: 2005.9.17 09:35

(14) In the attribute information, because information relating to the content of the text is not included, information of “Who” and “How” cannot be obtained.

(15) However, the creation date and the last save date can be obtained, and these pieces of information are compared with When information. When information in this example is “When*range start ( [symbol] )”, “When*range start (11 [symbol] )”, and “When*range end ( [symbol] )”.

(16) At first, it is assumed that “When*range start ( [symbol] )” is the next month based on the creation date of the text in the example, that is, “2005.9.15 14:35”, and month information “September” of the creation date is added to determine that the next month is October. Because the year is the same and date and time are uncertain, “2005.10” is supplemented.

(17) Because specific month is specified in “When*range start (11 [symbol] )”, it is off the subject of information supplement.

(18) It is assumed from “When*range end ( [symbol] ) that it is the end of year 2005 from the text creation date and the last save date, to obtain the year information “2005” from the text creation date and the last save date. Because the end of the year can be specified as December 31st, “2005.12.31” is supplemented as specific date.

(19) Replace the extracted information with the supplementary information, to specify the extracted 4W1H-plus-predicate information as “What ( [symbol] )”, “When*range (from 2005.10 to 2005.12.31)”, “Where ( [symbol] )”, “When*range (from November to 2005.12.31)”, and Where ( [symbol] )”.

(20) The extracted information “What ( [symbol] )” and “When*range end ( [symbol] )” related to the next predicate [symbol] is also compared with the attribute information. It is assumed that “When*range end ( [symbol] )” is the end of year 2005 from the text creation date and the last save date, to obtain the year information “2005” from the text creation date and the last save date. Because the end of the year can be specified as December 31st, “2005.12.31” is supplemented as specific date.

(21) Replace the extracted information with the supplementary information, to specify the extracted 4W1H-plus-predicate information as “What ( [symbol] )” and “When*range end (12.31 [symbol] )”.

(22) Upon completion of the information supplement process relative to all sentences in the text, if there is an output command, execute the output process. An output example of extracted data of the text in FIG. 4 in this case is shown in the output example 804 in FIG. 8.

FIG. 9 is a flowchart of a 4W1H-plus-predicate information extraction process according to the first embodiment. In the explanations below, extraction of the 4W1H-plus-predicate information is simply referred to as element information extraction or element extraction.

The registering unit 11 receives a 4W1H-plus-predicate information-extraction command, registers the document information, and stores the document information in the document storage unit 16a (step S101). The analyzer 12 analyzes the document information stored in the document storage unit 16a (step S102). The analysis process will be described later.

The element extracting unit 13 performs the element extraction process for the analyzed document information (step S103). The element extraction process will be described later. The supplementary-information obtaining unit 14 obtains supplementary information from the attribute information accompanying the document information, performs the supplement process for the target document information, and stores the extracted 4W1H-plus-predicate information undergone the supplement process in the extracted-information storage unit 16c (step S104).

The display controller 17 determines whether output command to display the information on the monitor has been received (step S105). When the output command has been received (YES at step S105), the extracted 4W1H-plus-predicate information and the like are displayed on the monitor 18 (step S106). When the output command has not been received (NO at step S105), the display controller 17 finishes the process.

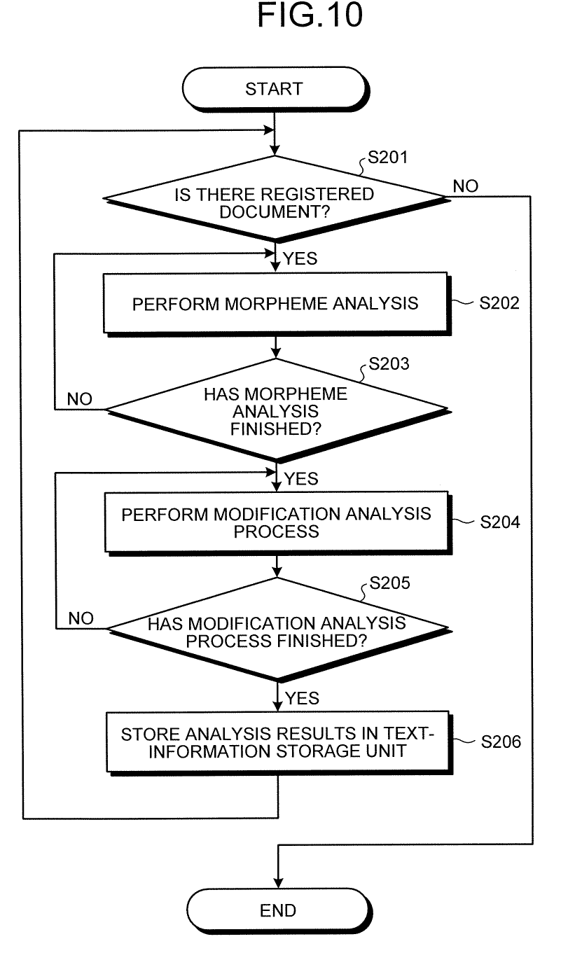

FIG. 10 is a flowchart of the analysis process. The analyzer 12 determines whether there is a registered document (step S201). If there is no registered document (NO at step S201), the analyzer 12 finishes the process. When there is a registered document (YES at step S201), the morpheme analyzer 12a performs morpheme analysis on the text stored in the document storage unit 16a. The morpheme analysis is a process of dividing the text into each word and adding an attribute of each word such as a part of speech (step S202). The morpheme analyzer 12a determines whether the morpheme analysis has finished (step S203), and if not (NO at step S203), the process control returns to step S202.

When the morpheme analysis process has finished (YES at step S203), the modification analyzer 12b performs modification analysis process relative to the registered document. The modification analysis is a process for creating a clause, which is one unit in the modification process, to identify in what relationship respective clauses are. Relating to the parts of speech as the attribute of words, detailed parts of speech are added, such as proper noun or temporal noun for the noun, and date affix, place affix, group affix, or numeral affix for the affix (step S204). It is then determined whether the modification analysis process has finished (step S205), and if not (NO at step S205), the modification analyzer 12b performs the modification analysis process again (step S204). When the modification analysis process has finished (YES at step S205), the analyzer 12 stores analysis results of the morpheme analysis process and the modification analysis process in the text-information storage unit 16b (step S206), and the process control returns to step S201.

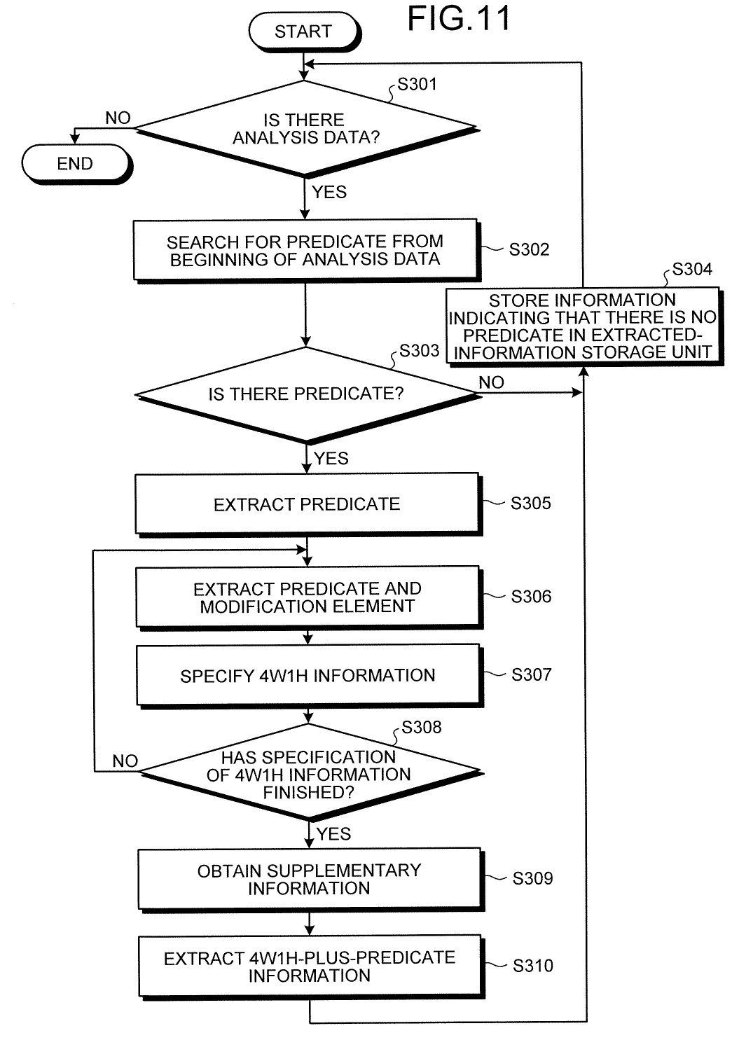

FIG. 11 is a flowchart of the 4W1H-plus-predicate information extraction process. The element extracting unit 13 determines whether there is data of analysis result in the text-information storage unit 16b (step S301), and if not (NO at step S301), finishes the process. When there is data (YES at step S301), the element extracting unit 13 searches for a predicate from the beginning of the read analysis data (step S302). The predicate specifically stands for a declinable word and an end-of-sentence clause terminated with a substantive.

The element extracting unit 13 determines whether there is a predicate (Step S303), and if not (NO at step S303), stores information indicating that there is no predicate in the extracted-information storage unit 16c (Step S304), and the process control returns to step S301.

On the other hand, when determining that there is a predicate (YES at step S303), the element extracting unit 13 extracts the predicate (Step S305).

The element extracting unit 13 searches for a clause directly modifying the predicate, and a clause directly adnominal-formed by the predicate. When such a clause can be found, the element extracting unit 13 extracts and stores the clause, the attribute, and the modification relationship of the predicate (step S306).

The element extracting unit 13 performs extraction of the 4W1H information. The element extracting unit 13 extracts and specifies 4W1H (When, Where, Who, What, and How) information and predicate from the language information (step S307). The element extracting unit 13 then determines whether the 4W1H information has been specified (step S308), and if not (NO at step S308), the process control returns to step S306 for specifying operation.

When the element extracting unit 13 determines that the 4W1H information has been specified (YES at step S308), the supplementary-information obtaining unit 14 obtains the supplementary information (step S309). The element extracting unit 13 then supplements the specified 4W1H information by using the obtained supplementary information (step S310), and stores the information in the extracted-information storage unit 16c (step S304). Then, the process control returns to step S301. When the process has finished relative to the whole analysis data, and there is no other analysis data (NO at step S301), the element extracting unit 13 finishes the process.

As described above, according to the first embodiment, in the information extracting apparatus 10, relevant information of each topic in the text can be accurately extracted as the 4W1H-plus-predicate information, without inputting a keyword or defining information extraction beforehand by the user. For example, when a user reads a document by using the data, the user can understand the document content more quickly and easily, as compared to a case that the document is read by using the conventional keyword extraction method, in which the user refers to the extracted keyword to understand the document content, because the document content can be understood intuitively by referring to the information associated with 4W1H and predicate. Accordingly, management, browsing, analysis, and reuse of the collected and accumulated documents can be realized accurately and easily.

In information extraction, with the knowledge dictionary 15b, the 4W1H-plus-predicate information can be specified not based on surface pattern matching of words and clauses and pattern matching based on regular expression, but based on condition match using the syntactic structure of the text and grammar characteristic of Japanese, and therefore highly accurate information extraction can be realized. For example, if information is extracted from the text

[symbol]

[symbol]

0 [symbol] [symbol] 11 [symbol] [symbol] [symbol] [symbol] based on the surface pattern ┌▪ [symbol] and regular expression [symbol] as in the conventional art, date range cannot be obtained in the former case because [symbol] and [symbol] are put therebetween, and in the latter case, either one of 10 [symbol] [symbol] (from October to the end of the year) or 11 [symbol] [symbol] (from November to the end of the year) can be obtained. However, if the knowledge dictionary of the information extracting apparatus 10 is used, information of
┌10 [symbol] = [symbol] 11 [symbol] = [symbol] − [symbol] (from October to the end of the year=the headquarters building, from November to the end of the year=the Ginza Showroom”) can be accurately obtained.

When necessary information cannot be obtained from a target sentence, the information extracting apparatus 10 can supplement the information from other parts of the text, and therefore the information extracting apparatus 10 can obtain detailed and necessary information.

When necessary information cannot be obtained from a target sentence, the information extracting apparatus 10 can fetch information other than the text to supplement the information, and therefore the information extracting apparatus 10 can obtain detailed and necessary information.

Further, because the information extracting apparatus 10 can accurately extract range information, and discriminate between date range and place range, the information extracting apparatus 10 can extract accurate information.

The process of extracting the 4W1H information from the document information described in an agglutinative language such as Japanese has been explained. However, according to the first embodiment, the 4W1H information can be extracted from the document information described in a non-agglutinative language such as English. This is explained below.

When an English text is to be handled, there is only a difference in the configuration in that the morpheme analyzer 12a included in the analyzer 12 in FIG. 1 is not required. In other words, the analyzer has only the modification analyzer 12b. In the explanation below, like reference characters refer to parts corresponding to those described above.

The analyzer 12 performs the analysis process for each document relative to the text part of the document information stored in the document storage unit 16a. At the time of analysis, the analyzer 12 refers to the analysis dictionary 15a. In the case of English text, the morpheme analysis process is not performed in the analysis process, and the modification analyzer 12b performs the modification analysis process.

The modification analyzer 12b specifies a word or a phrase formed by combining two or more words to have a meaning, which functions as one part of speech but does not include a relationship of a subject and a predicate verb, and performs the modification analysis process for identify which type of relationship a word and a word, a word and a phrase, and a phrase and a phrase have.

For example, in a sentence “He ate an apple.”, the modification analyzer 12b identifies that the word “He” as a pronoun is grammatically in a modification relationship with a predicate verb “ate”, and the modification relationship name is “subject-predicate relationship”, and the predicate verb “ate” and a noun phrase “an apple” are grammatically in a modification relationship, and the modification relationship name is “objective relationship”.

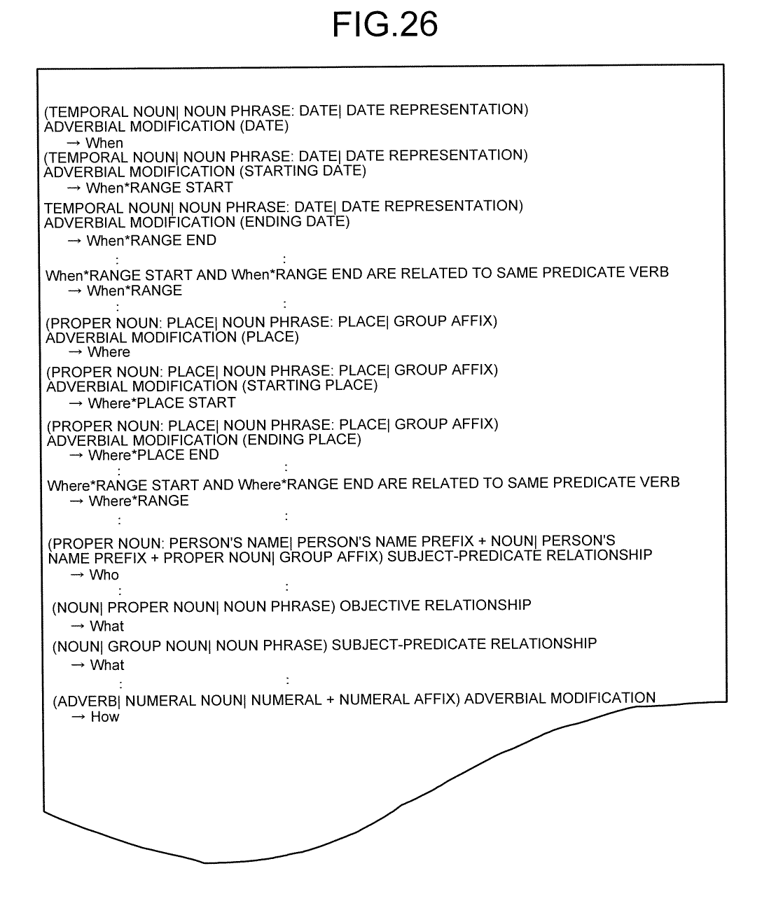

FIG. 26 is another example of a description in the knowledge dictionary 15b. The knowledge dictionary 15b describes semantic interpretation in which specific parts-of-speech information of words belonging to words and phrases or combinations of pieces of specific parts-of-speech information, relationship information between a modification destination of the words and phrases and modification are associated with information indicating any one of 4W1H (When, Where, Who, What, and How). By adopting a description method by regular expression, a concise description can be made.

As a component of the dictionary, a semantic attribute can be added to the semantic interpretation of 4W1H. In the example of the knowledge dictionary in FIG. 26, detailed semantic attributes such as “range start”, “range end”, and “range” are added to When information and Where information.

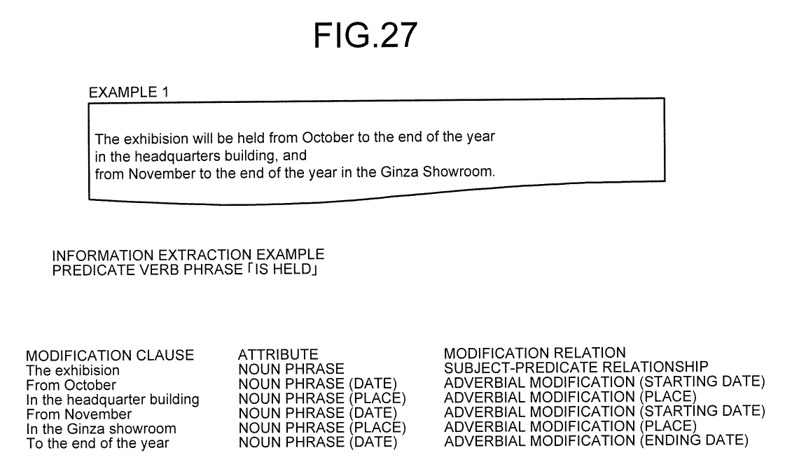

An example of the process of 4W1H-plus-predicate information extraction from an English sentence is explained with reference to FIG. 27. Example 1 is a document example, and words and phrases having a direct modification relationship with a predicate verb phrase “will be held”, the attribute of the words and phrases, and the modification relationship are extracted from an example of English text, “The exhibition will be held from October to the end of the year in the headquarters building, and from November to the end of the year in the Ginza Showroom”.

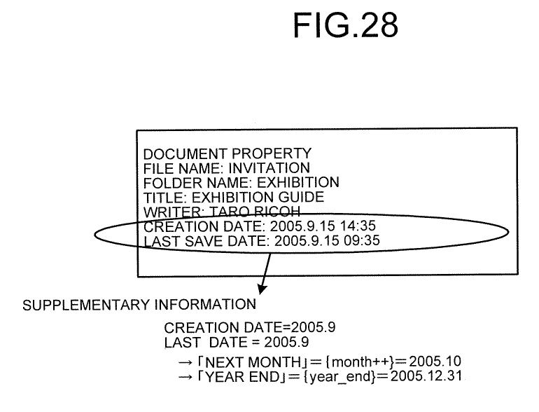

FIG. 28 is an example of a document property. The document property is automatically added to the document at the time of document registration, and is used as attribute information. In this example, specific date “next month” and “the end of the year” in the text are calculated from the creation date and the last save date of the document property and obtained as the supplementary information. If other pieces of information, for example, equipment information, application information, and place information can be obtained, these pieces of information are used as the attribute information for supplementing the information.

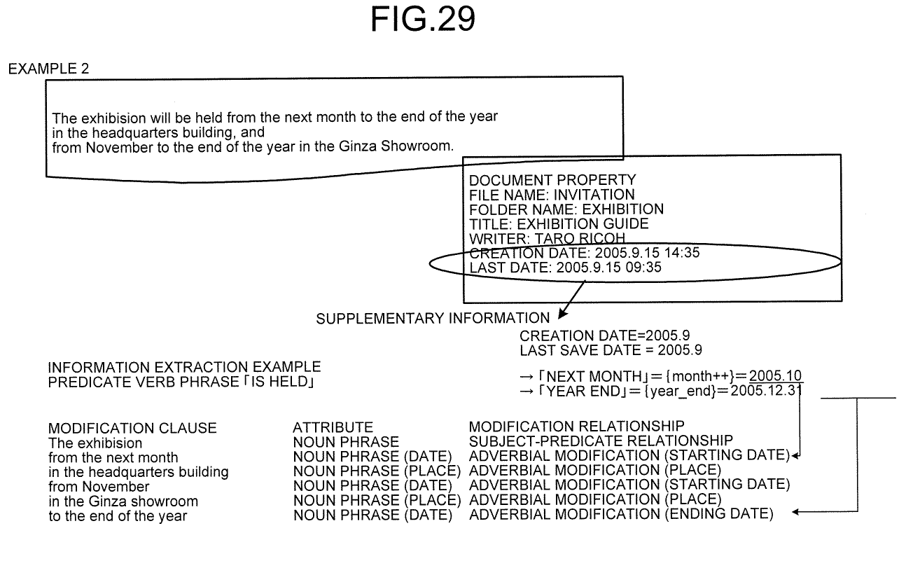

FIG. 29 is a schematic for explaining an example of the process in which the supplementary-information obtaining unit extracts information from the document property (attribute information) of the text for information supplement. Example 2 is another document example, and the 4W1H information extracted from a sentence in the Example 2 is supplemented by the information extracted from the attribute information.

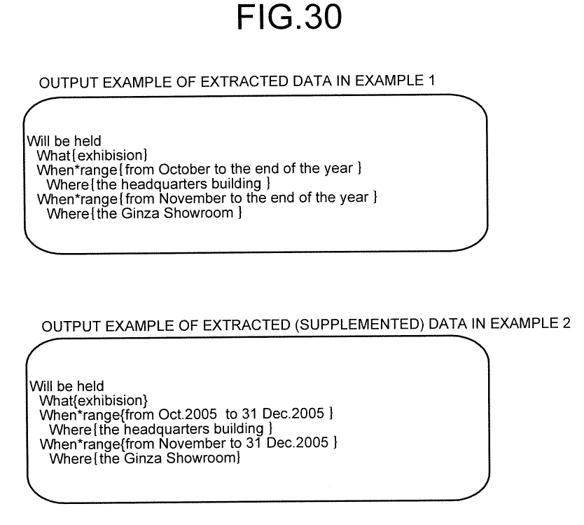

FIG. 30 is an output example of each (supplemented) data extracted from the Example 1 and the Example 2.

When respective output examples of the Example 1 and the Example 2 are compared with each other, in the output example of the Example 1, the 4W1H information including only the information extracted from the relevant sentence in the text part is output, whereas in the output example of the Example 2, time range information can be obtained in more detail from the document property (attribute information) of the text, in addition to the information extracted from the relevant sentence in the text part. That is, information of October as the Next month and 31 December as the end of the year is obtained and supplemented.

The analysis process performed by the information extracting apparatus in the case of the non-agglutinative language in the first embodiment is explained with reference to FIG. 27, taking a process relative to the document example, the Example 1, as an example. It is assumed that the information extracting apparatus is started up, and the registering unit registers a text including a sentence “The exhibition will be held from October to the end of the year in the headquarters building, and from November to the end of the year in the Ginza Showroom”.

In the information extracting apparatus, the document storage unit stores therein the registered document, and the analyzer performs the analysis process. The modification analyzer performs the modification analysis process by referring to the analysis dictionary. An example of a result of the modification analysis process in the case of the non-agglutinative language is shown below.

| No. | Phrase writing | Attribute | Modification | Modification destination |
|---|---|---|---|---|
| 1 | The exhibition | Noun phrase | Subject-predicate | 2 |
| | | | relationship | |
| 2 | will be held | Verb phrase | End of sentence | 2 |
| 3 | from October | Noun phrase (date) | Adverbial modification | 2 |
| | | | (starting date) | |
| 4 | to the end of | Noun phrase (date) | Adverbial modification | 2 |
| | the year | | (ending date) | |
| 5 | in the headquarters | Noun phrase (place) | Adverbial modification | 2 |
| | building | | (place) | |
| 6 | from November | Noun phrase (date) | Adverbial modification | 2 |
| | | | (starting date) | |
| 7 | to the end of | Noun phrase (date) | Adverbial modification | 2 |
| | the year | | (ending date) | |
| 8 | in the Ginza | Noun phrase (place) | Adverbial modification | 2 |
| | Showroom | | (place) | |

When the modification analysis process for one sentence has finished, the analyzer stores the analysis result in the text-information storage unit.

When there is the next sentence in the registered text, the analyzer performs the modification analysis relative to the next sentence. This operation is repeated until there is no next sentence in the text, and when the analysis process has finished for all the sentences, control proceeds to the element extraction process by the element extracting unit.

The element extracting unit extracts an analysis result for the first sentence from the text-information storage unit, to search for a predicate verb from the last phrase. The last phrase in the first sentence is “in the Ginza showroom”, phrase number 8.

The predicate verb phrase “will be held” is extracted from phrase number 2, and writing “will be held” is temporarily stored.

A phrase directly modifying phrase number 2 is searched for sequentially from phrase number 8 toward the first phrase.

Because the phrase number as the modification destination of phrase number 8 is 2, it can be seen that the phrase of phrase number 8 is directly infinitive-modifying the predicate verb phrase “will be held”. Therefore, writing of “in the Ginza showroom” and attribute thereof, “noun phrase (place)”, and the modification relationship “adverbial modification (place)” are stored.

A phrase directly modifying phrase number 2 is further searched for sequentially from phrase number 7 toward the first phrase.

Because the phrase number as the modification destination of phrase number 7 is 2, it can be seen that the phrase of phrase number 7 is directly infinitive-modifying the predicate verb phrase “will be held”. Therefore, writing of “to the end of the year” and attribute thereof, “noun phrase (date)”, and the modification relationship “adverbial modification (ending date)” are stored.

A phrase directly modifying phrase number 2 is further searched for sequentially from phrase number 6 toward the first phrase.

Because the phrase number as the modification destination of phrase number 6 is 2, it can be seen that the phrase of phrase number 6 is directly infinitive-modifying the predicate verb phrase “will be held”. Therefore, writing of “from November” and attribute thereof, “noun phrase (date)”, and the modification relationship “adverbial modification (starting date)” are stored.

A phrase directly modifying phrase number 2 is further searched for sequentially from phrase number 5 toward the first phrase.

Because the phrase number as the modification destination of phrase number 5 is 2, it can be seen that the phrase of phrase number 5 is directly infinitive-modifying the predicate verb phrase “will be held”. Therefore, writing of “in the headquarters building” and attribute thereof, “noun phrase (place)”, and the modification relationship “adverbial modification (place)” are stored.

A phrase directly modifying phrase number 2 is further searched for sequentially from phrase number 4 toward the first phrase.

Because the phrase number as the modification destination of phrase number 4 is 2, it can be seen that the phrase of phrase number 4 is directly infinitive-modifying the predicate verb phrase “will be held”. Therefore, writing of “to the end of the year” and attribute thereof, “noun phrase (date)”, and the modification relationship “adverbial modification (ending date)” are stored.

A phrase directly modifying phrase number 2 is further searched for sequentially from phrase number 3 toward the first phrase.

Because the phrase number as the modification destination of phrase number 3 is 2, it can be seen that the phrase of phrase number 3 is directly infinitive-modifying the predicate verb phrase “will be held”. Therefore, writing of “from October” and attribute thereof, “noun phrase (date)”, and the modification relationship “adverbial modification (starting date)” are stored.

Because the phrase number as the modification destination of phrase number 1 is 2, it can be seen that the phrase of phrase number 1 is directly infinitive-modifying the predicate verb phrase “will be held”. Therefore, writing of “The exhibition” and attribute thereof, “noun phrase”, and the modification relationship “subject-predicate relationship” are stored, thereby finishing the extraction of related phrase elements.

A predicate verb is then searched for from phrase number 2 toward the first phrase.

Because any predicate verb is not detected, extraction of the predicate verb and the related phrase elements in the example is finished. The extraction result is the information extraction example of the Example 1.

The extracted and temporarily stored information is collated with the knowledge dictionary, and if there is information matching the knowledge dictionary, the 4W1H information is specified, respectively.

From the description of “(Noun|group affix|noun phrase) Subject-predicate relationship→What” in the knowledge dictionary, it is specified that “exhibition” is “What”.

From the description of “Temporal noun|noun phrase: date|date representation) Adverbial modification (starting date)→When*Range start”,

“Temporal noun|noun phrase: date|date representation) Adverbial modification (ending date)→When*Range end”,

“When*Range start and When*Range end are related to the same predicate→When*Range”,

it is specified that “from October to the end of the year” is “When*Range”.

Further, it is specified that “from November to the end of the year” is “When*Range”.

From the description of “Proper noun: place|noun phrase: place|group noun) Adverbial modification (place)→Where”, it is specified that “headquarters building” and “Ginza showroom” are “Where”.

Respective pieces of specified 4W1H information are stored in a unit of 4W1H in the extracted-information storage unit.

Extraction of predicate verb and related phrase elements and specification and storage of the 4W1H information are repeated relative to all sentences in the text.

When information extraction has finished relative to all sentences in the text, the output process is executed upon reception of an output command.

Output of the extracted data of the text in this example becomes like an output example of the extracted data in the Example 1 shown in FIG. 30.

An example in which the 4W1H information is supplemented by the attribute information is explained with the Example 2 in FIG. 29.

It is assumed that the information extracting apparatus is started up, and a text including a sentence “The exhibition will be held from the next month to the end of the year in the headquarters building, and from November to the end of the year in the Ginza Showroom” is registered.

The information extracting apparatus stores the registered document in the document storage unit, and proceeds to the analysis process. In the analysis process, the same process as described above is performed. Upon completion of the analysis process, the same process as the element extraction process described above is performed, to obtain the information extraction example of the Example 2, and the 4W1H information is specified and stored.

It is then checked if all pieces of information of 4W1H have been obtained relative to respective sentences in the text.

In the text of the Example 2, “What (exhibition)”, “When*Range start (next month)”, “Where (the headquarters building)”, “When*Range start (November)”, “Where (the Ginza showroom)”, and “When*Range end (the end of the year)” can be specified, and these pieces of information are stored in a unit of 4W1H in the extraction-information storage unit.

Information lacking in the 4W1H information in the sentence is recognized. In this example, it is recognized that there is no “Who” and “How” information.

The following information is obtained as the attribute information from the document property shown in FIG. 28:

File Name: Invitation

Folder Name: Exhibition

Title: Exhibition guide

Creator: Taro Ricoh

Creation Date: 2005.9.15 14:35

Last Save Date: 2005.9.16 09:35

Because the attribute information does not include information relating to the content of the text, “Who” and “How” information cannot be obtained.

However, the creation date and the last save date can be obtained, and the information is compared with When information. When information in this example is “When*Range start (next month)”, “When*Range start (November)”, and “When*Range end (the end of the year)”.

At first, it is assumed that “When*Range start (next month)” is “next month” based on “2005.9.15 14:35” at the time of creating the text in this example, and 1 is added to the month information “9” of the creation date, to assume that next month is “10”. The year is the same, and because the day and time are not clear, “2005.10” is supplemented.

“When*Range start (November)” is off the subject to be supplemented, because specific month is specified.

It is assumed that “When*Range end (the end of the year)” is the end of the year 2005 based on the text creation date and the last save date in this example. The year information “2005” of the creation date and the last save date is obtained, and because the end of the year can be specified as December 31st, “2005.12.31” is supplemented as specific date.

The extracted information is replaced by the supplementary information, to specify the extracted 4W1H-plus-predicate verb information as What (exhibition), When*Range (from October 2005 to 31 Dec. 2005), Where (the headquarters building), When*Range (from November to 31 Dec. 2005), Where (the Ginza showroom).

When the information supplement process has finished relative to all sentences in the text, the output process is executed upon reception of an output command. An output example in which the output example of the extracted data of the text in FIG. 29 is supplemented by an output example of the extracted (supplemented) data in FIG. 28 is shown in an output example of the extracted (supplemented) data in the Example 2 shown in FIG. 30.

Thus, even in the case of English texts, the 4W1H information can be extracted from the text as in the case of Japanese texts.

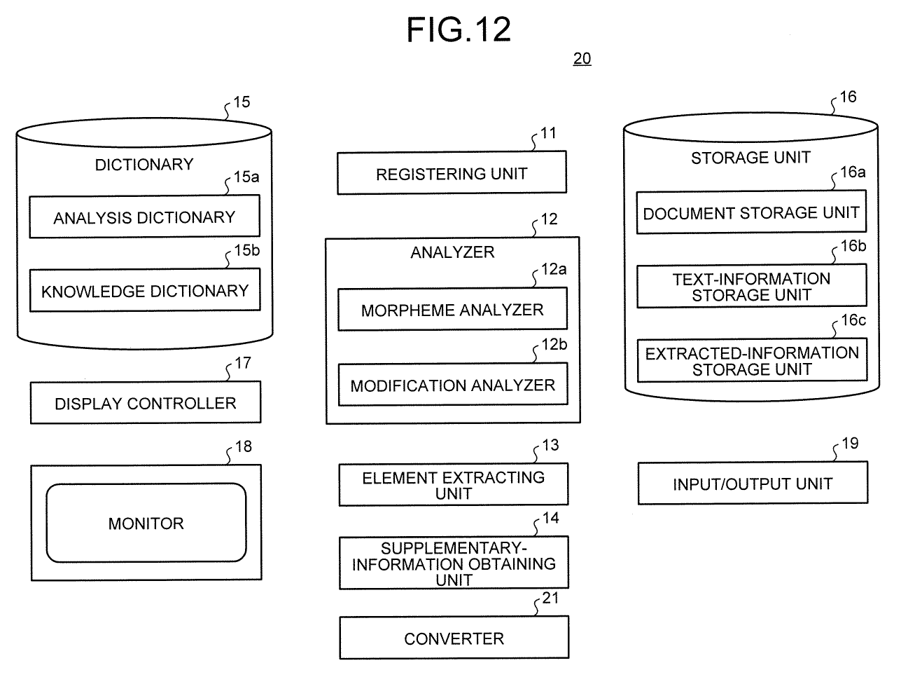

FIG. 12 is a functional block diagram of an information extracting apparatus 20 according to a second embodiment of the present invention. The information extracting apparatus 20 is basically similar to the information extracting apparatus 10 except for the presence of a converter 21.

Differently from the first embodiment, the converter 21 converts a 4W1H-plus-predicate information group associated by the element extracting unit 13 into the computer readable and interpretable data representation.

Accordingly, because the information extracting apparatus 20 automatically converts the 4W1H-plus-predicate information group into the computer readable and interpretable data representation, the user can convert information-extracted data into computer processable data on a Web page without requiring special Extensible Markup Language (XML) and Resource Description Framework (RDF) syntax knowledge and without using labor.

The converter 21 converts the 4W1H-plus-predicate information extracted by the element extracting unit 13 and supplemented with the supplementary information obtained by the supplementary-information obtaining unit 14 into an RDF/XML syntax, which is the computer readable and interpretable data representation. RDF is officially recommended by a standardization group W3C. For example, a Uniform Resource Identifier (URI) http://example.org/a/term defining vocabularies in the 4W1H information is prepared, and an affix thereof is expressed as a: and is used together with existing vocabularies (for example, Dublin Core). If there is an existing vocabulary matching the target document, newly defined vocabulary need not be prepared. After the 4W1H information is obtained by information extraction, the converter converts the information together with the attribute information into, for example, the RDF/XML syntax and stores the RDF/XML syntax. Alternatively, the converter can convert the information into an RDF graph format and the graph can be displayed on a display unit such as a monitor.

Further, the converter 21 can convert the information into the computer readable and interpretable data representation other than the RDF, and for example, if target data is event information such as a schedule, the converter can convert the data into a standard format iCalender format.

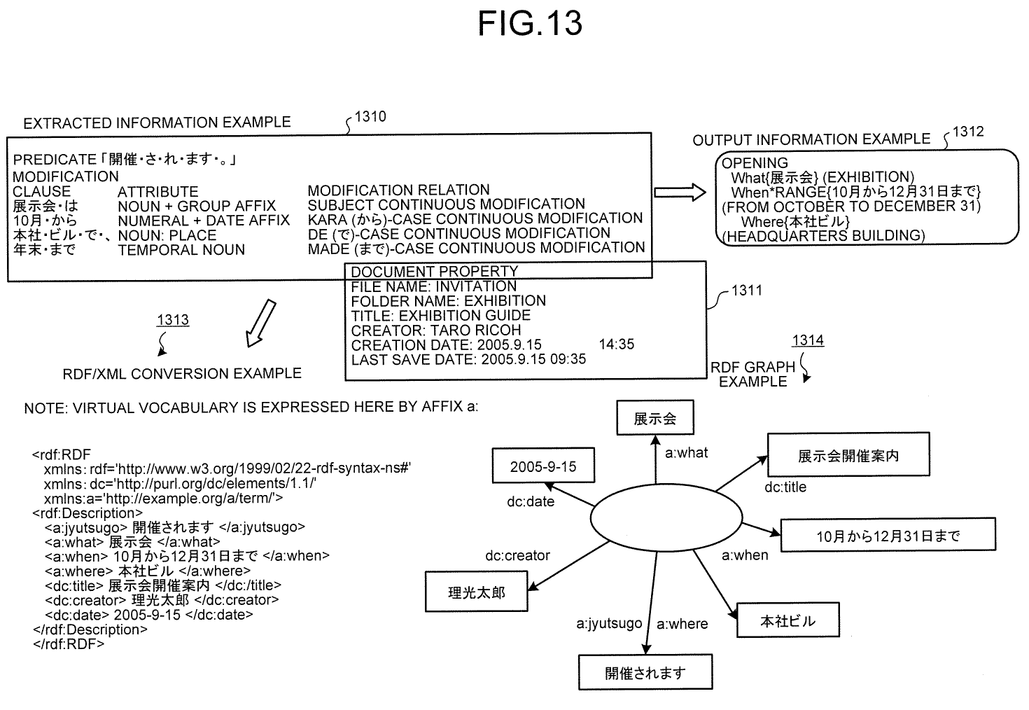

FIG. 13 is a schematic for explaining conversion examples in which the converter converts an obtained extraction element into the RDF/XML syntax and an RDF graph. It is assumed herein that the information extracting apparatus 20 is started up, and a text including a sentence [symbol] 10 [symbol] [symbol] [symbol] [symbol] | is registered. At this time, simultaneously with test registration, a document property 1311 shown in FIG. 13 is automatically added. For this purpose, a function attached to a conventional front end processor can be used.

The conversion process to the computer readable data representation is explained in more detail. The converter 21 performs the conversion process to the computer readable data representation. The RDF/XML syntax is explained as an example of the computer readable data representation.

(1) For example, prepare an URI defining vocabularies having the 4W1H information as a property element, in this example, http://example.org/a/term in advance, and express the affix thereof as, for example “a:”, and use it together with the existing vocabularies (for example, Dublin Core), as in the RDF/XML conversion example in FIG. 13. If there is an existing vocabulary matching the target document, this vocabulary is used, and newly defined vocabulary need not be prepared.

(2) Extract information from the extracted-information storage unit 16c in a unit of 4W1H. For example, an output information example 1312 in FIG. 13 can be obtained.

(3) Describe a blank node indicating text content in the RDF/XML syntax.

(4) Describe the predicate [symbol] as a node element.

(5) Describe What information [symbol] as a node element.

(6) Describe When information 10 [symbol] [symbol] as a node element.

(7) Describe Where information [symbol] as a node element.

(8) Obtain the attribute information, if possible. In this example, assume a case that the document property information shown in FIG. 13 can be obtained, and describe a document title [symbol] [symbol] creator [symbol] , and creation date “2005-9-15” as the node element by using an affix of Dublin Core.

(9) Store these pieces of information. Upon reception of an output command, execute the output process. In FIG. 13, an RDF/XML conversion example 1313 of the extracted information and an RDF graph conversion example 1314 are shown. The RDF/XML syntax or the RDF graph format shown in FIG. 13 can be directly output, or processed and presented so that the user can easily understand.

According to the second embodiment, the associated information group can be automatically converted into the computer readable and interpretable data representation. Accordingly, the user can convert information-extracted data into machine-processable data on a Web page without requiring special XML and RDF syntax knowledge and without using labor.

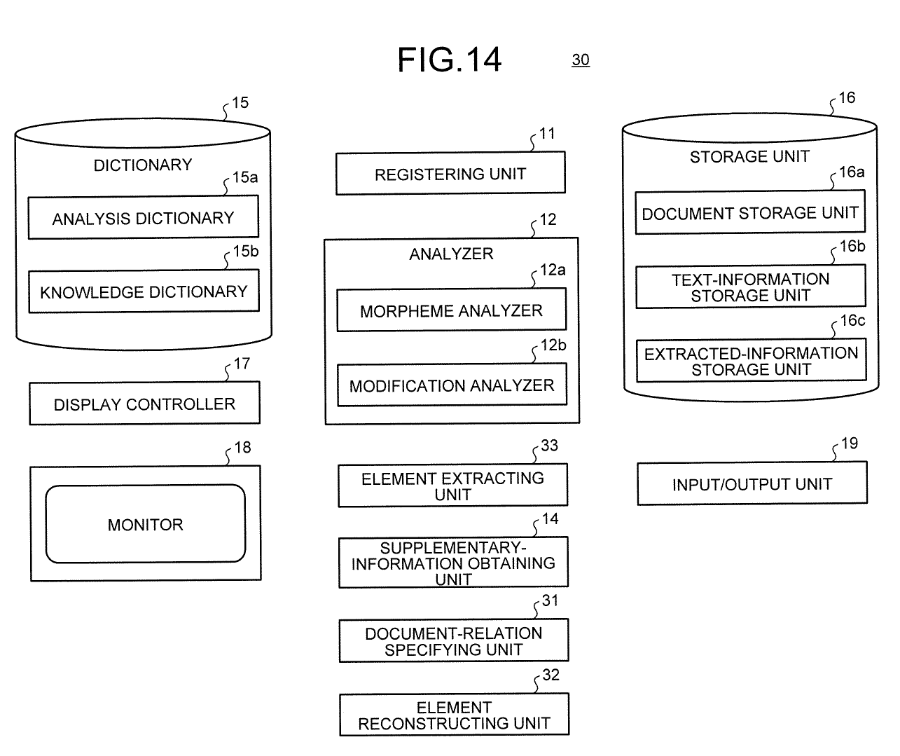

FIG. 14 is a functional block diagram of an information extracting apparatus 30 according to the third embodiment. The information extracting apparatus 30 is basically similar to the information extracting apparatus 10 except for a document-relationship specifying unit 31 and an element reconstructing unit 32. Therefore, the same description is not repeated.

Differently from the information extracting apparatus 10, the information extracting apparatus 30 specifies an inter-document relationship to reconstruct the 4W1H-plus-predicate information from the information extracted from the respective pieces of document information based on the specified relationship between the documents.

Because the 4W1H-plus-predicate information is reconstructed from the 4W1H-plus-predicate information extracted from the respective pieces of document information based on the relationship between them, the 4W1H-plus-predicate information most suitable in the relationship between the documents can be extracted from the pieces of document information.

The document-relationship specifying unit 31 specifies an inter-document relationship. The element extracting unit 33 extracts the 4W1H-plus-predicate information from the text information. The element reconstructing unit 32 reconstructs the 4W1H-plus-predicate information from the 4W1H-plus-predicate information extracted by the element extracting unit 32 based on the relationship between the documents specified by the document-relationship specifying unit 31.

The relationship between the documents specified by the document-relationship specifying unit 31 is, for example, a transfer relationship in a plurality of transferred emails. When the relationship is displayed, for example, in a tree format, the relationship can be taken as an inter-document structure.

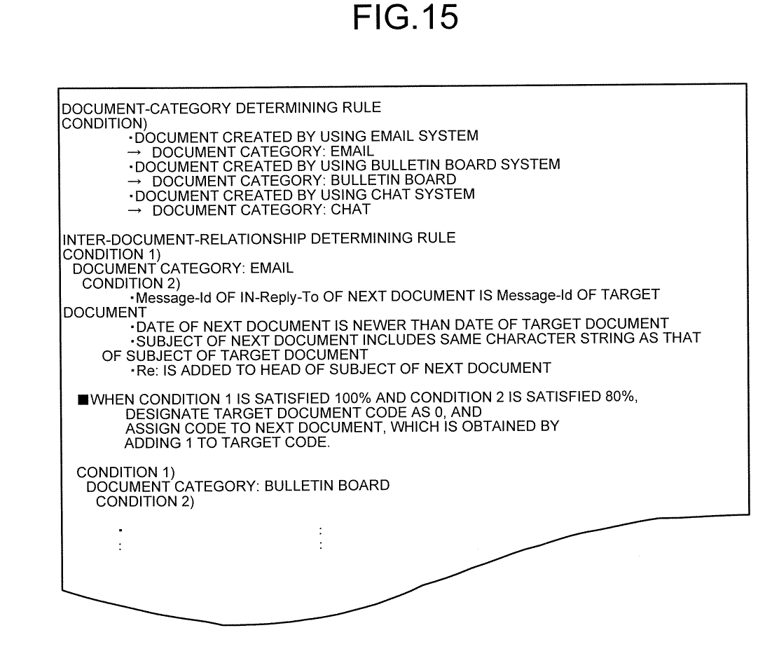

FIG. 15 is a schematic for explaining a document-relationship specifying rule applied to specify the inter-document relationship by the document-relationship specifying unit 31. The document-relationship specifying unit 31 obtains a target document group upon reception of a specifying command, reads one document, obtains header information of the document, and stores the information in a buffer. The document-relationship specifying unit 31 then obtains the header information of the next document in the similar manner, to analyze those pieces of header information of both documents based on the document-relationship specifying rule shown in FIG. 15.

For example, when the document-relationship specifying unit 31 determines that the document group is an email document group based on the header information of the document group, the document-relationship specifying unit 31 specifies an issue sequence of the two documents and a response relationship, which is a reply mail to an original mail, gives a document relationship code, and stores these pieces of information together with issue date information of the document. If there is the next document, the document-relationship specifying unit 31 obtains the header information of the document, compares the header information with the one obtained immediately before, specifies the relationship between these two documents based on the document-relationship specifying rule, gives a document relationship code, and stores these pieces of information together with the issue date information of the document. Upon completion of header comparison and analysis, and relationship specification of the obtained whole document group, the document-relationship specifying unit 31 stores the documents and the document structure of the target document group expressed by the document relationship code, to finish the process.

The technique by which the element extracting unit 32 extracts the 4W1H-plus-predicate information from the respective pieces of document information is as explained in the first embodiment. As in the first embodiment, it is desired that the element extracting unit 32 extract the 4W1H-plus-predicate information based on the analysis by the analyzer 12 and the supplementary information obtained by the supplementary-information obtaining unit 14. Upon completion of information extraction from one document, the element extracting unit 32 stores the extracted element together with the relationship information derived from the language information, and executes the element extraction process from syntactic information of the next document. When the element extraction process relative to all sentences in one document has finished, the element extracting unit 32 executes the same element extraction process from the first sentence in the next document. When the element extraction process is performed relative to all registered documents, the element extracting unit 32 finishes the process. In the element information to be extracted here, the 4W1H and predicate information cannot be completely obtained, derived from the original text.

The element reconstructing unit 32 receives an element (4W1H-plus-predicate information) reconstructing command, to reconstruct the 4W1H-plus-predicate information based on the inter-document structure information of the target document group and the 4W1H-plus-predicate information of the respective documents. This reconstruction operation will be explained in detail in a reconstruction process. However, briefly, the element reconstructing unit 32 stores 4W1H and predicate in the first sentence of one document in a first read buffer, and compares these with 4W1H and predicate in the next sentence. If there is a repetition of 4W1H attribute information, or there is information having the same attribute but different writing, the element reconstructing unit 32 adds the repeated information to the respective pieces of information. Further, if there is no 4W1H and predicate in the next sentence, the element reconstructing unit 32 checks whether the 4W1H and predicate group at this point in time satisfies the necessary 4W1H-plus-predicate information, and when the 4W1H and predicate group satisfies the 4W1H-plus-predicate information, selects the reconstructed 4W1H-plus-predicate information to finish the element reconstruction process.

A description example of the document-relationship specifying rule in FIG. 15 is explained. For example, the document-relationship specifying rule includes a document-category determining rule, thereby verifying the header information and bibliographic information of a document, and determining whether the target document is an email document, a contributed document on a bulletin board, or a contributed document in a chat. Further, the document-relationship specifying rule includes an inter-document-relationship determining rule, thereby collating the header information and bibliographic information of two documents with each other, and specifying the relationship between the two documents matched with a description condition, for example, by adding a document code thereto. Although this example is written in the text format, in the case of system installation, it is desired to use a rule in which these conditions are written in a program code format.

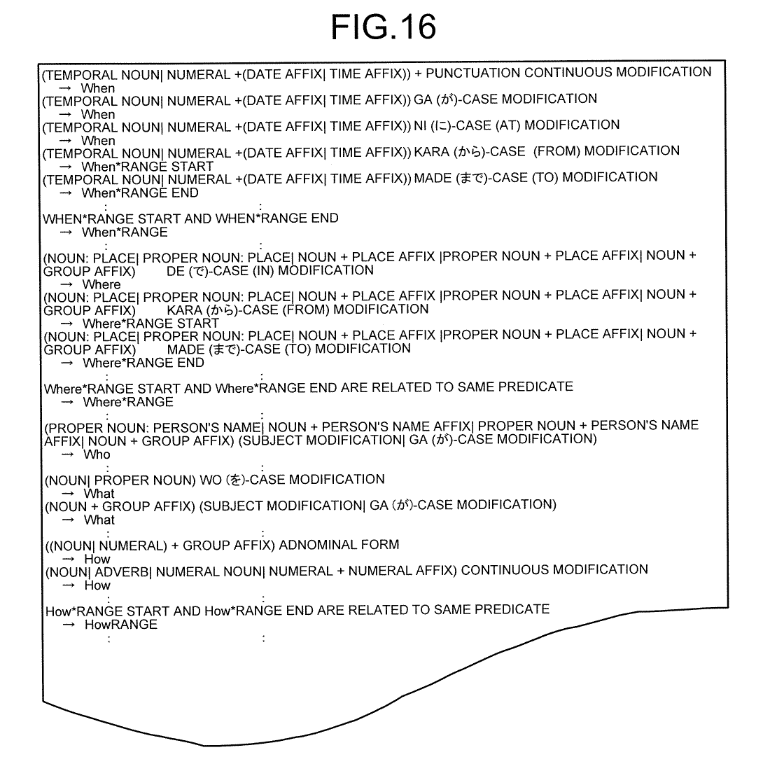

FIG. 16 is another example of a description in the knowledge dictionary. The knowledge dictionary used by the element extracting unit 32 is as explained below. In this example, grammar information is described in a format of regular expression. However, in the case of system installation, it is desired to use a rule in which these conditions are written in the program code format. Syntactic information of the text can be collated with the knowledge dictionary, to extract matching information as the 4W1H information from the syntactic information.

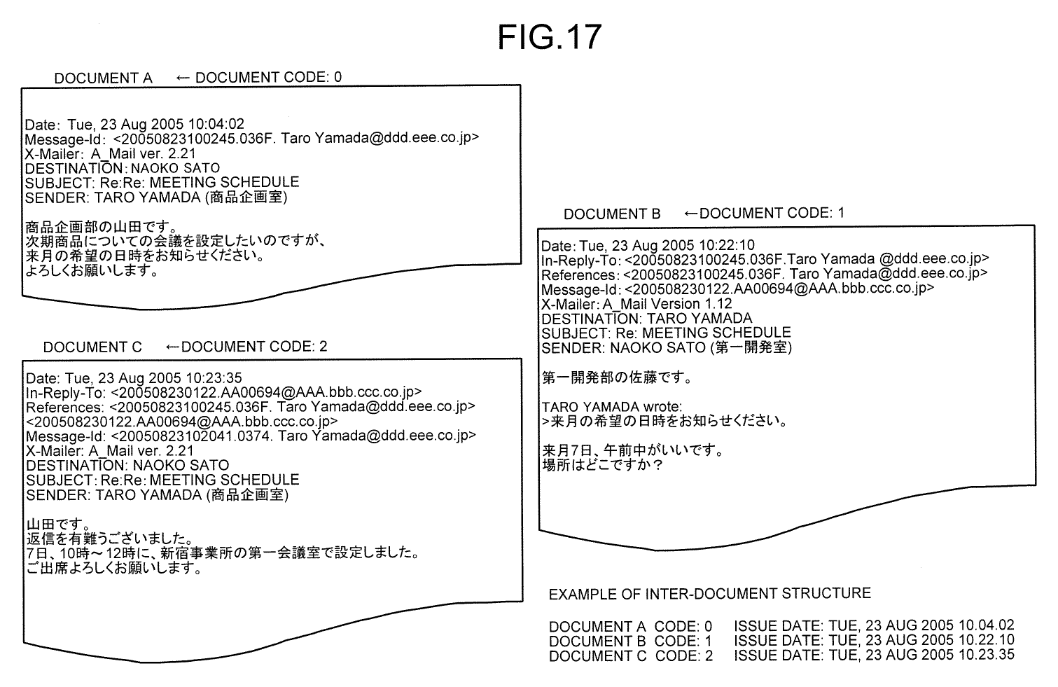

FIG. 17 is a schematic for explaining extraction of an inter-document relationship in an email document group by the information extracting apparatus 30. FIG. 17 depicts an example of a document group to be processed. A document relationship-specifying process is explained with reference to FIGS. 15 and 17. For example, it is assumed that the information extracting apparatus 30 according to the embodiment of the present invention is started up, and documents A, B, and C in FIG. 17 are registered. The supplementary-information obtaining unit 14 in the information extracting apparatus 30 obtains the header information of a document A and the header information of a document B, and stores these pieces of information in the buffer. The header information is as follows:

### Header of Document A:

### Date: Tue,23Aug200510:04:02

### Message-Id: <20050823100245.036F.TaroYamada@ddd.eee.co.jp>

### X-Mailer: A_Mailver.2.21

### Header of Document B:

### Date: Tue,23Aug200510:22:10

### In-Reply-To: <20050823100245.036F.TaroYamada@ddd.eee.co.jp>

### References: <20050823100245.036F.TaroYamada@ddd.eee.co.jp>

### Message-Id: <200508230122.AA00694@AAA.bbb.ccc.co.jp>

### X-Mailer: A_MailVersion1.12

The document-relationship specifying unit 31 determines that these documents are the email document group using a mail system, from the respective pieces of header information “X-Mailer: A_Mailver.2.21” and “X-Mailer: A_Mailversion.1.12”.

Referring to the document-relationship specifying rule in FIG. 15, these documents satisfy a condition 1 of the document-relationship specifying rule 100%. When the document A is designated as a target document, and the document B is designated as the next document, the document relationship specifying unit 31 determines that In-Reply-To Massage-Id “20050823100245.036F.

TaroYamada@ddd.eee.co.jp” of the next document is Message-Id of the target document, that Date “Tue,23Aug200510:22:10” of the next document is newer timewise than Date “Tue,23Aug200510:04:02” of the target document, that there is the same character string in the subject “Re: meeting schedule” of the next document as the subject “Meeting schedule” of the target document, and that Re: is added to the head of the subject of the next document. These satisfy a condition 2 of the document-relationship specifying rule in FIG. 15 100%. Because these documents satisfy the conditions 1 and 2 100%, the document-relationship specifying unit 31 specifies that the relationship between these documents A and B is in a response relationship in the mail system, and gives code 0 to the document A, which is the target document, and code 1 to the next document B, which has the response relationship.

The document-relationship specifying unit 31 shifts the document by one, leaves the header information of the document B as it is, and stores the header information of a document C in the buffer. The header information is as follows:

### Header of Document C:

### Date: Tue,23Aug200510:23:35

### In-Reply-To: <200508230122.AA00694@AAA.bbb.ccc.co.jp>

### References: <20050823100245.036F.TaroYamada@ddd.eee.co.jp><200508230122.AA00694@AAA.bbb.ccc.co.jp>

### Message-Id: <20050823102041.0374.TaroYamada@ddd.eee.co.jp>

### X-Mailer:A_Mailver.2.21

The document-relationship specifying unit 31 determines that these documents are the email document group using the mail system based on the respective pieces of header information “X-Mailer: A_Mailversion1.12” and “X-Mailer: A_Mailver2.21”. Referring to the document-relationship specifying rule in FIG. 15, these pieces of information satisfy the condition 1 of the document-relationship specifying rule in FIG. 15 100%. When the document B is designated as a target document, and the document C is designated as the next document, the document relationship specifying unit 31 determines that In-Reply-To Message-Id “200508230122.AA00694 @AAA.bbb.ccc.co.jp” of the next document is Message-Id of the target document, that Date “Tue,23Aug200510:23:35” of the next document is newer timewise than Date “Tue,23Aug200510:22:10” of the target document, that there is the same character string in the subject “Re:Re: Meeting schedule” of the next document as the subject “Re: Meeting schedule” of the target document, and that Re: is added to the head of the subject of the next document. These satisfy the condition 2 of the document-relationship specifying rule in FIG. 15 100%. Because these documents satisfy the conditions 1 and 2 100%, the document-relationship specifying unit 31 specifies that the relationship between these documents B and C is in a response relationship in the mail system, and assigns 2 to the document C, which is obtained by adding 1 to the code of the document B as the target document whose code is 1.

According to the process performed by the document-relationship specifying unit 31, it can be specified that the document group of documents A, B, and C in FIG. 17 is the email document group being in a series of response relationship, and that the document group structure is such that the document A is an original document of the email, the document B is a reply mail document to the document A, and the document C is a reply mail document to the document B. Accordingly, the document-relationship specifying unit 31 can extract the inter-document structure:

| | | |
|---|---|---|
| Document A | Code: 0 | Issue date: Tue, 23Aug200510:04:02 |
| Document B | Code: 1 | Issue date: Tue, 23Aug200510:22:10 |
| Document C | Code: 2 | Issue date: Tue, 23Aug200510:23:35 |

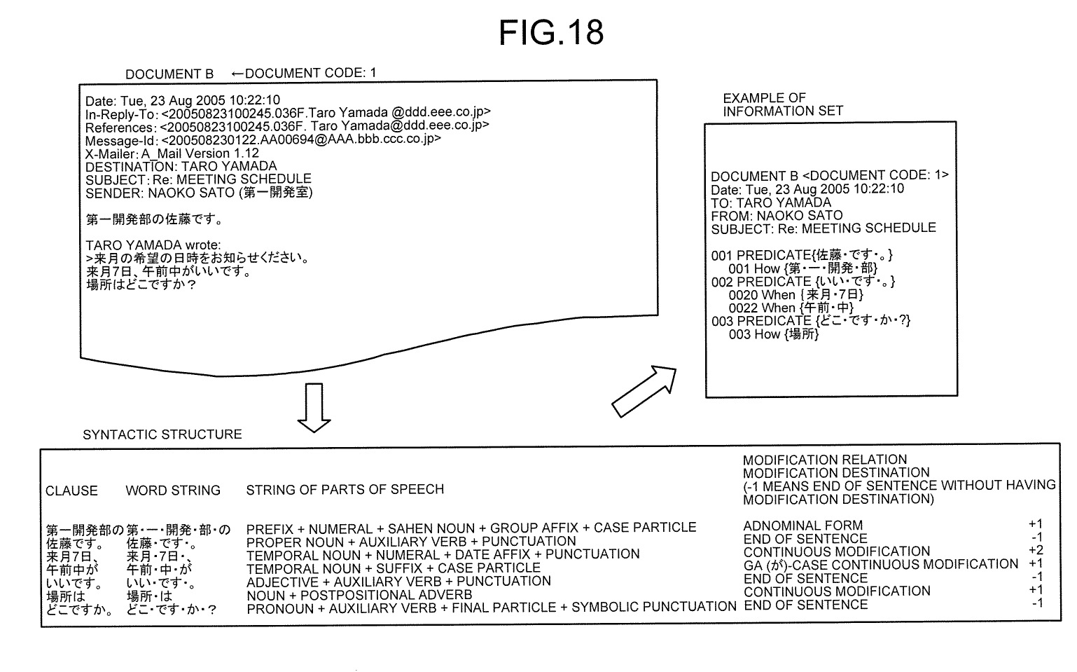

FIG. 18 is a schematic for explaining extraction of the 4W1H-plus-predicate information (element) from document B shown in FIG. 17 by a syntactic process.

The information extracting apparatus 30 is started up, and documents A, B, and C in FIG. 17 are registered. The element extracting unit 32 extracts 4W1H and predicate in the document A in the order of registration, and starts the element extraction process for the document B, upon completion of extraction for the document A. The element extracting unit 32 first obtains syntactic information of a text excluding a header part of the document B. The text excluding the header part is as described below.

### Text Part:

### α TaroYamadawrote: >

(I am Sato from the First development division. TaroYamadawrote:>Please inform the date and time of the (meeting of the) next month you prefer. I prefer the morning of the 7th of the next month. Where is the (meeting) place?)

At this time, when there is a description of ┌◯◯ [symbol] [symbol] (“xxxwrote:”) in the text, the entire sentence when the same code but unrelated to the sentence is given to the head of the description and a sentence immediately thereafter is regarded as a cited part, and processed as off the subject to be extracted. Accordingly, the syntactic information-obtaining target text is as described below.

Syntactic information-obtaining target text part:

[symbol]

[symbol]

[symbol]

[symbol]

[symbol]

[symbol]

The element extracting unit 32 analyzes the syntactic information-obtaining target text part, thereby obtaining a syntactic structure, for example, as shown in FIG. 18. A conventional analysis method such as the morpheme analysis and the modification analysis can be used for the analysis.

Syntactic Structure:

| | | | | Modification |
|---|---|---|---|---|
| Clause | Word string | Parts of speech | Modification | destination |
| [symbol] | [symbol] | Prefix + numeral + sahen | Adnominal form | +1 |
| | | noun + group affix + case | | |
| | | particle | | |
| [symbol] | [symbol] | Proper noun + auxiliary | End of sentence | −1 |
| | | verb + punctuation | | |
| [symbol] | [symbol] | Temporal noun + numeral + date | Continuous modification | +2 |
| | | affix + punctuation | | |
| [symbol] | [symbol] | Temporal noun + suffix + case | Ga-case continuous | +1 |
| | | particle | modification | |
| [symbol] | [symbol] | Adjectives + auxiliary | End of sentence | −1 |
| | | verb + punctuation | | |
| [symbol] | [symbol] | Noun + postpositional | Continuous modification | +1 |
| | | adverb | | |
| [symbol] | [symbol] | Pronoun + auxiliary verb + particle | End of sentence | −1 |
| | | at the end of sentence + symbolic | | |
| | | punctuation | | |

(−1 means end of sentence without having modification destination)

Upon completion of the syntactic information obtaining process, the element extracting unit 32 extracts and specifies 4W1H (When, Where, Who, What, and How) and predicate from the obtained syntactic information. The element extracting unit 32 searches for predicate from the head of the text with the syntactic information. Specifically, the predicate stands for a declinable word, a clause at the end of sentence, or the like. When searching the syntactic structure of the document B from the head of the text, the element extracting unit 32 finds a clause at the end of sentence [symbol] α as the predicate. When the predicate can be specified, the element extracting unit 32 gives a code to the predicate and searches for a clause directly modifying the predicate and a clause directly adnominal-formed by the predicate. When there is such a clause, the element extracting unit 32 extracts the clause, attribute thereof, and the modification relationship with the predicate, gives the same code as that of the predicate thereto, and stores these pieces of information. When there is a plurality of pieces of information having the same attribute in the same set, the element extracting unit 32 additionally gives a low order code to distinguish the codes. Because there is a clause [symbol] that directly modifies the clause at the end of sentence [symbol] , the element extracting unit 32 extracts the clause writing, the attribute such as a string of parts of speech, and the modification relationship, and stores these pieces of information. When all clauses directly modifying the predicate can be extracted, the element extracting unit 32 specifies any one of 4W1H with respect to the respective clauses based on the attribute and the modification relationship relative to the predicate. A method of using, for example, the knowledge dictionary shown in FIG. 16, which describes knowledge using the grammar characteristic, can be used for specifying 4W1H. Because there is no other clause directly modifying [symbol] or clause directly adnominal-formed by [symbol] , the element extracting unit 32 applies the knowledge dictionary in FIG. 16 to two clauses of [symbol] and [symbol] and the attribute thereof, to specify any one of 4W1H and predicate. [symbol] is a predicate, and the attribute of [symbol] is “sahen noun+group affix” of the string of parts of speech, and the modification relationship thereof is “adnominal form”, which matches “(noun|numeral)+group affix), (adnominal form)→How” in the knowledge dictionary, and How can be specified.

Upon completion of specification, the element extracting unit 32 searches for the next predicate. When searching for the next predicate of [symbol] , the element extracting unit 32 finds a clause [symbol] . When searching for a clause that directly modifies the clause [symbol] and a clause directly modified by the predicate, the element extracting unit 32 finds a clause [symbol] and a clause [symbol] and extracts the clause writing, the attribute thereof such as the string of parts of speech, and the modification relationship, and stores these pieces of information. The element extracting unit 32 applies the knowledge dictionary in FIG. 16 to these clauses to specify any one of 4W1H and predicate. [symbol] is a predicate, and the attribute of [symbol] is “temporal noun+numeral+date affix+punctuation” of the string of parts of speech, and the modification relationship thereof is “continuous modification”, which matches “(temporal noun|numeral+date affix|time affix)+punctuation, (continuous modification)→When” in the knowledge dictionary, and When can be specified. Further, regarding [symbol] , the attribute is “temporal noun+suffix+case particle” of the string of parts of speech, and the modification relationship thereof is “ga-case continuous modification”, which matches “temporal noun|numeral+date affix|time affix)” ga-case modification→When” in the knowledge dictionary, and When can be specified.

When the next predicate of [symbol] is searched for, a predicate [symbol] is found. When searching for a clause that directly modifies the clause [symbol] and a clause directly modified by the predicate, the element extracting unit 32 finds a clause [symbol] , and extracts the clause writing, the attribute such as the string of parts of speech, and the modification relationship, and stores these pieces of information. The element extracting unit 32 applies the knowledge dictionary in FIG. 16 to the clause to specify any one of 4W1H and predicate. [symbol] is a predicate, and the attribute of [symbol] is “noun+postpositional adverb” of the string of parts of speech, and the modification relationship thereof is “continuous modification”, which matches “(noun|adverb|numeral noun|numeral+numeral affix), continuous modification→How” in the knowledge dictionary, and How can be specified. Upon completion of specification, the element extracting unit 32 searches for the next predicate. This process is repeated until no other predicate can be found. Because there is no predicate following [symbol] , the element extracting unit 32 finishes the element extraction process for the document B.

Thus, upon completion of the element extraction process to all sentences in one document, the element extracting unit 32 executes the same element extraction process from the first sentence in the next document. When the element extraction process is performed relative to all registered documents, the element extracting unit 32 finishes the process. As shown in FIG. 18, 4W1H and predicate information extracted from the document B is as follows:

001 Predicate [ [symbol] ]
001 How [ [symbol] ]

002 Predicate [ [symbol] ]
0020 When [ [symbol] ]

0021 When [7 [symbol] ]

0022 When [ [symbol] ]

003 Predicate [ [symbol] ]
003 How [ [symbol] ]

At the time of element extraction, if the target document is an email document, the supplementary-information obtaining unit 14 pre-extracts “subject”, “sender”, and “receiver” other than the text part as the 4W1H-plus-predicate information derived from the bibliographic information. The element extracting unit 32 pre-specifies that the “subject” is What information, and “sender” and “receiver” are Who information, and adds these pieces of information to the respective elements of 4W1H and predicate as supplementary information. This is because the subject and the sender's and receiver's names in the email play an important role in the event's accompanying representation of the email document, and therefore improvement in the information extraction accuracy can be expected.

If the target document is a bulletin board document, the supplementary-information obtaining unit 14 pre-extracts “subject for discussion” and “creator” in the document, and the element extracting unit 32 pre-specifies “subject for discussion” and “creator” as What information and Who information, respectively, and adds these pieces of information to the respective elements of 4W1H and predicate as the supplementary information.

If the target document is a chat document, the supplementary-information obtaining unit 14 pre-extracts “date” and “user” in the document, and the element extracting unit 32 pre-specifies the “date” and “user” as What information and Who information, respectively, and adds these pieces of information to the respective elements of 4W1H and predicate as the supplementary information.

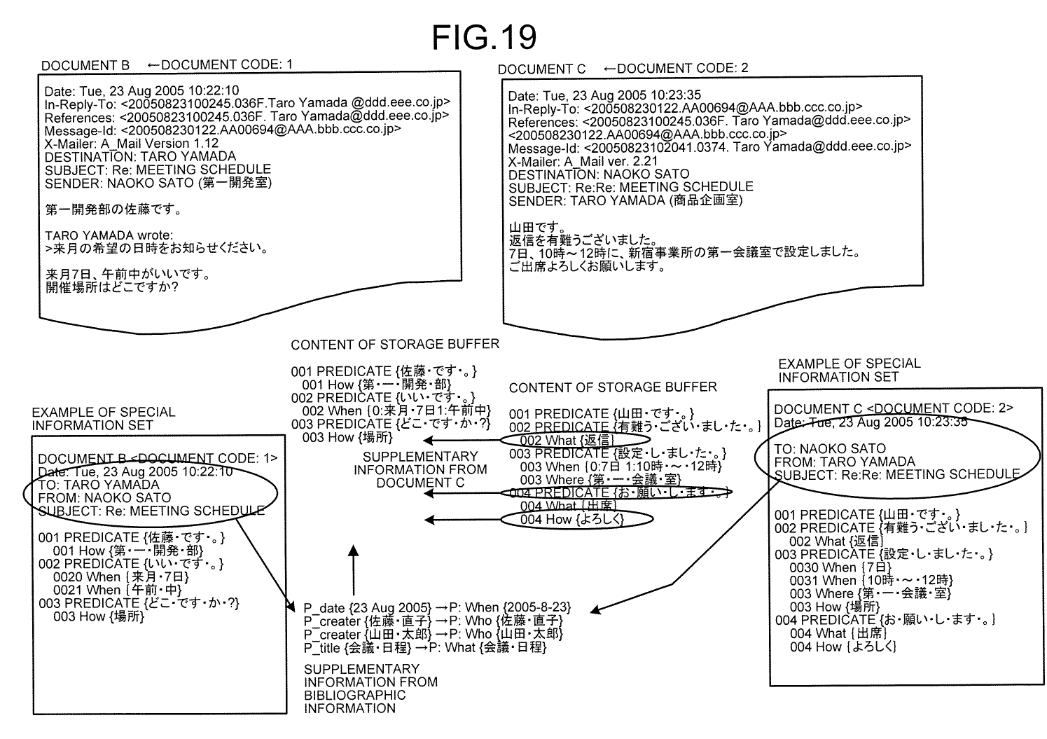

FIG. 19 is a schematic for explaining extraction of 4W1H-plus-predicate information from documents B and C shown in FIG. 17, and an example in which information is supplemented by the supplementary information. An example in which the 4W1H-plus-predicate information is supplemented by peripheral information of the document and other documents is explained with reference to FIGS. 17 and 19.

It is assumed that the information extracting apparatus 30 is started up and documents A, B, and C in FIG. 17 are registered. A shortage of 4W1H and predicate in the document B is supplemented by 4W1H-plus-predicate information in the document C and the peripheral information of documents B and C.

### (Supplement with Peripheral Information)

The supplementary information from the peripheral information of the document represented in bibliographical information shown in FIG. 19 is automatically added at the time of document registration. The bibliographical information of the document is used as the peripheral information for supplementing the 4W1H-plus-predicate information.

A method for obtaining the bibliographical information beforehand by using a conventional method such as pattern matching, a method in which a user specifies supplement target information with respect to the bibliographical information, and the like can be used for supplementing the 4W1H-plus-predicate information. The peripheral information includes so-called context information of the document such as an update history of the document, a created place of the document, creation equipment information of the document, used application information, an access history of the document, in addition to, for example, the bibliographical information of the document.

For example, following information is known as the bibliographical information of a certain software product, that is, file name, current folder name, template, title, sub-title, creator, key word, explanation, creation date, number of changes, last save date, and last saving person.

The 4W1H-plus-predicate information obtained from the bibliographical information is as follows:

### Document B:

P_date [23Aug2005]

P_creator [ [symbol] ]

P_title [ [symbol] ]

### Document C:

P_date [23Aug2005]

P_creator [ [symbol] ]

P_title [ [symbol] ]

The element extracting unit 32 combines these pieces of information and converts the information into the same form of presentation. For example, the date is standardized to representation of year-month-date. Date is converted into When information, creator is converted into Who information, title is converted into What information. The 4W1H information derived from the peripheral information is converted into easily understandable representation. The 4W1H-plus-predicate information from the bibliographic information is given P: at the head of the 4W1H information as follows:

P: When [2005-8-23]

P: Who [ [symbol] ]

P: Who [ [symbol] ]

P: What [ [symbol] ]

### (Supplement from Other Documents)

The information extracting apparatus 30 stores the registered document in the document storage unit, and performs the same process as the document relationship-specifying process to determine that documents B and C are in the response relationship on the mail system. The information extracting apparatus 30 obtains the syntactic structure relative to the respective documents described above to extract 4W1H and predicate, specifies the 4W1H-plus-predicate information, to obtain 4W1H and predicate in the respective documents of documents B and C as shown in FIG. 19, and stores 4W1H and predicate.

The information extracting apparatus 30 checks whether all pieces of information of 4W1H and predicate can be obtained from the first set, with respect to the respective 4W1H and predicates in the document B. The “predicate [ [symbol] ]” and “How [ [symbol] ]” can be obtained as 4W1H and predicate in the first set in the document B. The information missing in the 4W1H-plus-predicate information is recognized as “Who”, “What”, “When”, and “Where” information in this example. In the next set, it is recognized that “When [ [symbol] ]”, “When [7 [symbol] ]”, and “When [ [symbol] ]” can be obtained. Because there is no information for supplementing the missing information in the next 4W1H and predicate and there is no next 4W1H and predicate, the information extracting apparatus 30 recognizes that the missing information in 4W1H and predicate in the document B is “Who”, “What”, and “Where”, and finishes checking of the 4W1H-plus-predicate information in the document B.

The information extracting apparatus 30 checks presence of information capable of supplementing the missing information in the document B relative to the respective 4W1H and predicates in the document C. The information extracting apparatus 30 recognizes that the missing information in 4W1H and predicate in the document B is “Who”, “What”, and “Where” information. The information extracting apparatus 30 checks presence of information capable of supplementing the missing information from the first set. Although “predicate [ [symbol] ]” can be obtained as 4W1H and predicate in the first set of the document C, there is no information capable of supplementing the missing information, the information extracting apparatus 30 checks the next set.

The information extracting apparatus 30 recognizes that “What [ [symbol] ]” can be obtained in the next set. The information extracting apparatus 30 recognizes that “When [7 [symbol] ]”, “When [10 [symbol] ˜12 [symbol] ]”, and “Where [ [symbol] ]” can be obtained as the next 4W1H and predicate. The information extracting apparatus 30 further recognizes that “What [ [symbol] ]”, and “How [ [symbol] ]” can be obtained as the next 4W1H and predicate. Because “What [ [symbol] ]”, “What [ [symbol] ]”, and “Where [ [symbol] ]” are found as the information supplementing the missing information, and there is no next 4W1H and predicate, the information extracting apparatus 30 recognizes that the missing information in 4W1H and predicate in documents B and C is “Who” information, to finish checking of the 4W1H-plus-predicate information in the document C.

The information extracting apparatus 30 thus repeats recognizing the information missing in the 4W1H-plus-predicate information relative to each registered document, checking the presence of the supplementary information, and supplementing the information. Upon completion of the information supplement process relative to the registered documents, the element extracting unit 32 combines the 4W1H-plus-predicate information with the 4W1H information derived from the peripheral information. At this time, in the relationship between the 4W1H-plus-predicate information derived from the document and the 4W1H information derived from the peripheral information, the 4W1H-plus-predicate information derived from the document is basically given priority. This is because the topic in the document is considered to be reasonable as the 4W1H-plus-predicate information.

In the above example, 4W1H and predicate in the document B and the supplemented information are as follows:

### Document B Original

1001 predicate [ [symbol] ]
1001 How [ [symbol] ]

1002 predicate [ [symbol] ]
10020 When [ [symbol] ]
10021 When [7 [symbol] ]
10022 When [ [symbol] ]

1003 predicate [ [symbol] ]
1003 How [ [symbol] ]

### Supplementary Information from the Document C

2002 What [ [symbol] ]

2003 Where [ [symbol] ]

2004 What [ [symbol] ]

### Supplementary Information from Peripheral Information

P: When [2005-8-23]

P: Who [ [symbol] ]

P: Who [ [symbol] ]

P: What [ [symbol] ]

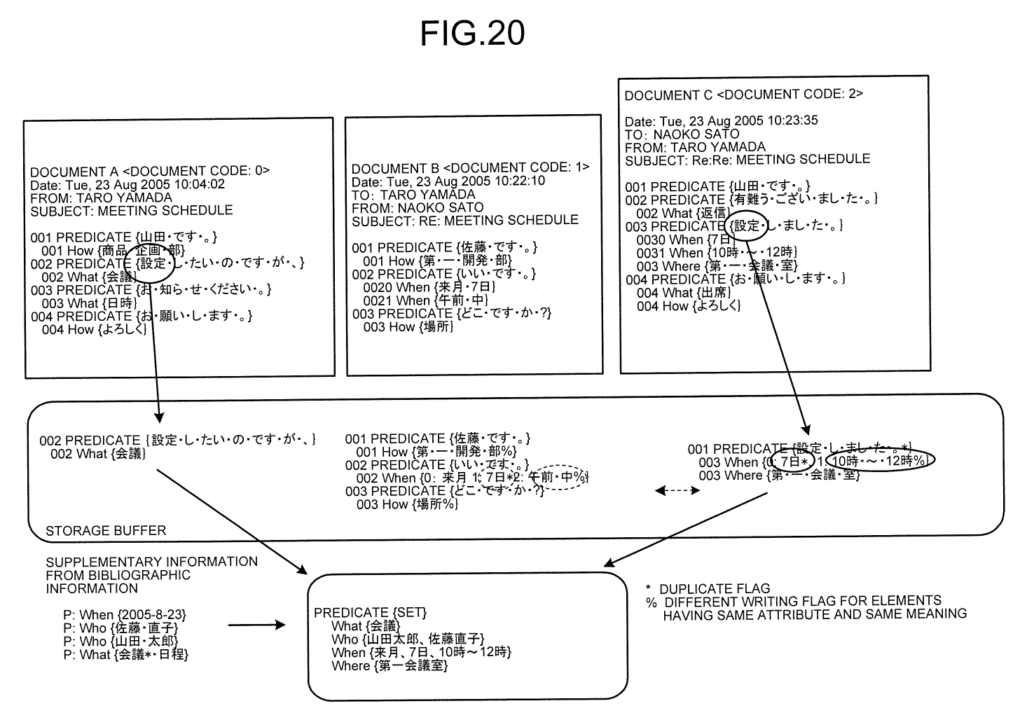

FIG. 20 is a schematic for explaining an example in which the element reconstructing unit 32 reconstructs the 4W1H-plus-predicate information from documents A, B, and C shown in FIG. 17. An example of the element reconstruction process by the element reconstructing unit 32 from the document group is explained with reference to FIGS. 17 and 20.

It is assumed that the information extracting apparatus 30 is started up and documents A, B, and C in FIG. 17 are registered. At this time, the supplementary-information obtaining unit 14 automatically adds the supplementary information by the context as shown in FIG. 20 at the same time with document registration. The information extracting apparatus 30 stores the registered document in the document storage unit, and performs the same process as the document relationship-specifying process explained above. The element extracting unit 32 extracts 4W1H and predicate from the syntactic structure with respect to the respective documents to execute the 4W1H-plus-predicate information-supplement process using the 4W1H-plus-predicate information in the document group and the peripheral information of the respective documents relative to 4W1H and predicate in the document group. 4W1H and predicate extracted from the respective documents and the supplementary information from the bibliographical information are shown in FIG. 20.

The element extracting unit 32 reads 4W1H and predicate extracted from the respective documents and the supplementary information from the bibliographical information to select the necessary 4W1H-plus-predicate information. A method for setting a selection standard at this time can include: a method in which a basic setting is set beforehand on the system side; a method in which the basic setting is set beforehand on the system side and the user can optionally customize the basic setting at the time of using the system; a method in which the user registers the setting beforehand; and a method in which all of 4W1H and predicates in the document group are displayed on the monitor 18 to be selected by the user. A method in which the basic setting is set beforehand on the apparatus side is explained here. For example, a case that the basic setting described below is set as output-requiring information on the information extracting apparatus 30 side.

### Predicate Selection Standard:

If there is a predicate common to all documents, assume the predicate as a predicate in a necessary information set and store the predicate;
If there is no predicate common to all documents, assume a predicate having a high rate of content in a wide range of documents as the predicate in the necessary information set and store the predicate;
If there is a plurality of common predicate, store these predicates.

### 4W1H Information Selection Standard:

Assume the 4W1H-plus-predicate information having the modification relationship with the predicate matching the predicate selection standard as an element of the necessary information set and store the 4W1H-plus-predicate information;
If there is no predicate matching the predicate selection standard, store all elements and delete an element outside of the necessary information set;
When there are elements having the same attribute and the same writing, add a duplication flag to the elements and select one element having a relationship with the predicate matching the predicate selection standard;
When there is a plurality of elements having the same attribute but different writing, select one element having a high value in a document code and an element code.

### Bibliographical Information Selection Standard:

Supplement a missing element of the necessary elements derived from the document information. If there are elements having the same attribute, give preference to the element derived from the document information.

Perform this process, and when 4W1H and predicate, which are the necessary elements, are not complete, the incomplete elements are output as it is.

The element extracting unit 32 searches for a predicate common to all documents by paying attention to the predicate of the read information. In this example, because there is no predicate common to all the documents A to C, the element extracting unit 32 assumes [symbol] (set) common to documents A and C as a predicate in the necessary information set and stores this information. The necessary information set stands for a set of 4W1H and predicate in target reconstruction elements.

### Predicate []

The element extracting unit 32 assumes 002 What [ [symbol] (meeting)], which is the 4W1H-plus-predicate information having the modification relationship with 002 ┌ [symbol] [symbol] ┘ (want to set), as the element of the necessary information set from 4W1H and predicate in the document A and stores this information.

Predicate [ [symbol] ]

0-002 What [ [symbol] ]

Because there is no other 4W1H-plus-predicate information having the modification relationship with 002 ┌ [symbol] [symbol] ┘ in the remaining 4W1H-plus-predicate information in the document A, the element extracting unit 32 searches for an element from 4W1H and predicate in the document B. However, because there is no predicate [symbol] in the document B, the element extracting unit 32 stores all elements of 4W1H and predicate in the document B.

Predicate [ [symbol] ]

0-002 What [ [symbol] ]

1-001 How [ [symbol] ·-· [symbol] · [symbol] · [symbol] ]

1-002 When [0: [symbol] 1:7 [symbol] 2: [symbol] ]

1-003 How [ [symbol] ]

The element extracting unit 32 assumes 003 When [0:7 [symbol] , 1:10 [symbol] ·˜·12 [symbol] ] and 003 Where [ [symbol] ·-· [symbol] · [symbol] ], which is the 4W1H-plus-predicate information having the modification relationship with 003 [ [symbol] ] as the elements of the necessary information set, from 4W1H and predicate in the document C and stores the elements.

Predicate [ [symbol] ]

0-002 What [ [symbol] ]

1-001 How [ [symbol] ·-· [symbol] · [symbol] ]

1-002 When [0: [symbol] 1:7 [symbol] 2: [symbol] · [symbol] ]

1-003 How [ [symbol] ]

2-003 When [0:7 [symbol] , 1:10 [symbol] ·˜·12 [symbol] ]

2-003 Where [ [symbol] ·-· [symbol] · [symbol] ]

Because there is no other 4W1H-plus-predicate information having the modification relationship with 003 [symbol] in the remaining 4W1H-plus-predicate information in the document C, and there is no next document, the element extracting unit 32 finishes search of 4W1H and predicate derived from the document information.

The element extracting unit 32 adds a duplication flag * to 1-002 When [1:7 [symbol] ] and 2-003 When [0:7 [symbol] ], which are the elements having the same attribute and same writing and stores these elements. The element extracting unit 32 further assigns a different writing flag % to 1-001 How [ [symbol] ·˜· [symbol] · [symbol] ] and 1-003 How [ [symbol] ], and to 1-002 When [ [symbol] · [symbol] ] and 2-003 When [1:10 [symbol] ·˜·12 [symbol] ], which are the elements having the same attribute but different writing, and stores these elements. The data is as follows:

Predicate [ [symbol] ]

0-002 What [ [symbol] ]

1-001 How [ [symbol] ·-· [symbol] · [symbol] ]

1-002 When [0: [symbol] 1:7 [symbol] *2: [symbol] · [symbol] %]

1-003 How [ [symbol] %]

2-003 When [0:7 [symbol] 1:10 [symbol] ·˜·12 [symbol] ]

2-003 Where [ [symbol] ·-· [symbol] · [symbol] ]

Extracts 1-002 When 0: [symbol] 1:7 [symbol] *2: [symbol] · [symbol] % in the document B having duplication and different writing relative to the 4W1H-plus-predicate information relating to the predicate [symbol] , and delete other 4W1H-plus-predicate information in the document B, that is, 1-001 How [ [symbol] ·-· [symbol] · [symbol] %] and 1-003 How [ [symbol] ].

Predicate [ [symbol] ]

0-002 What [ [symbol] ]

1-002 When [0: [symbol] 1:7 [symbol] *2: [symbol] · [symbol] %]

2-003 When [0:7 [symbol] *, 1:10 [symbol] ·˜·12 [symbol] %]

2-003 Where [ [symbol] ·-· [symbol] · [symbol] ]

According to the above process, it can be seen that Who attribute and How attribute are missing from the necessary elements 4W1H and predicate. Therefore, the supplementary information from the bibliographic information is used. P: When [2005-8-23] at the top indicates the creation date of the document, however, because there are elements derived from the document information, 1-002 When [0: [symbol] 1:7 [symbol] *2: [symbol] · [symbol] %] and 2-003 When [0:7 [symbol] *, 1:10 [symbol] ·˜·12 [symbol] %], these elements are given priority, and the creation date of the document is not added as the element of the 4W1H-plus-predicate information. Subsequent P: Who [ [symbol] · [symbol] ] and P: Who [ [symbol] · [symbol] ] are creators of the documents. Because the Who attribute is missing information of the necessary elements, these pieces of 4W1H-plus-predicate information are added as the necessary information.

Predicate [ [symbol] ]

0-002 What [ [symbol] ]

1-002 When [0: [symbol] 1:7 [symbol] *2: [symbol] · [symbol] %]

2-003 When [0:7 [symbol] *, 1:10 [symbol] ·˜·12 [symbol] ]

2-003 Where [ [symbol] ·-· [symbol] · [symbol] ]

P: Who [ [symbol] · [symbol] [symbol] · [symbol] ]

The next P: what [ [symbol] [symbol] ] has duplication with the element 0-002 What [ [symbol] ] derived from the document information, and therefore the duplication flag is added to both elements. However, because there is the element derived from the document information, this element is given priority, and P: what [ [symbol] · [symbol] ] is not added as the element of the 4W1H-plus-predicate information. Because there is no next 4W1H-plus-predicate information derived from the bibliographic information, element acquisition from the supplementary information from the bibliographic information finishes.

Information is then selected according to the basic setting. 2-003 When [0:7 [symbol] ], which is an element having a relationship with the predicate [symbol] matching the predicate selection standard is designated as a selection target from the duplicate information 1-002 When [1:7 [symbol] ] and 2-003 When [0:7 [symbol] ] of the necessary information. 2-003 When [1:10 [symbol] ·˜·12 [symbol] ] having a high document code is then designated as a selection target, from different writing information 1-002 When [2:| [symbol] · [symbol] ] and 2-003 When [1:|10 [symbol] ·˜·12 [symbol] ].

Of the necessary information, How attribute is missing. However, because it cannot be supplemented, the 4W1H and predicate selection result in this example is as follows.

Predicate [ [symbol] ]

What [ [symbol] ]

Who [ [symbol] , [symbol] ]

When [ [symbol] , 7 [symbol] , 10 [symbol] ˜12 [symbol] ]

Where [ [symbol] ]

The information extracting apparatus 30 can receive a predetermined condition to reconstruct the 4W1H-plus-predicate information from other sentences based on the inter-document relationship, to be adapted to the received condition. For example, the information extracting apparatus 30 reconstructs the information according to a sentence or a predicate as the condition, under the condition of the last sentence timewise, the first sentence timewise, or the most frequent predicate. Thus, by giving a condition, the information extracting apparatus 30 can reconstruct the 4W1H-plus-predicate information to be adapted to this condition.

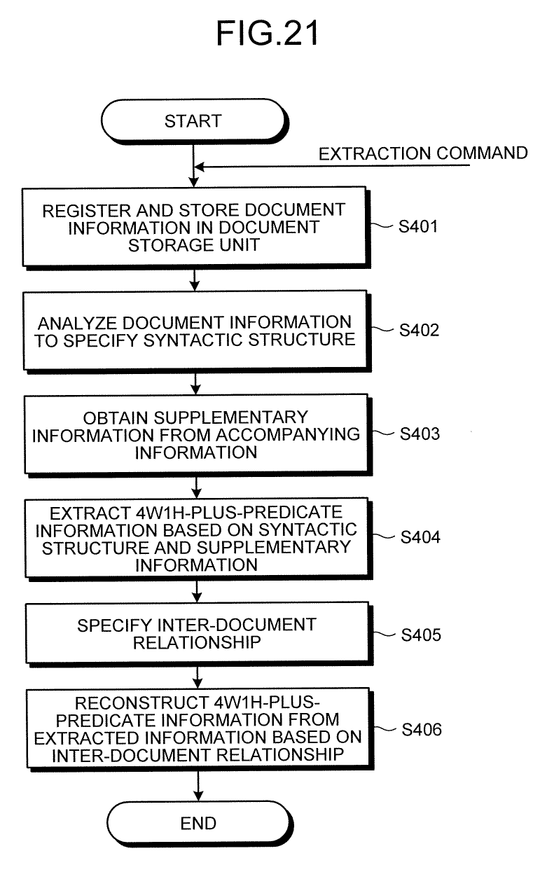

FIG. 21 is a flowchart of an information extraction process according to the third embodiment. The process from step S401 to step S404 is the same as previously described for the information extraction process according to the first embodiment in connection with FIG. 18, and the same explanation is not repeated. The process until the element extracting unit 32 extracts the 4W1H-plus-predicate information based on the syntactic structure and the supplementary information is the same as that in the first embodiment.

The document-relationship specifying unit 31 specifies an inter-document relationship (step S405). This step will be described later. The element reconstructing unit 32 reconstructs the 4W1H-plus-predicate information from the extracted 4W1H-plus-predicate information based on the inter-document relationship (step S406). This step will be described later.

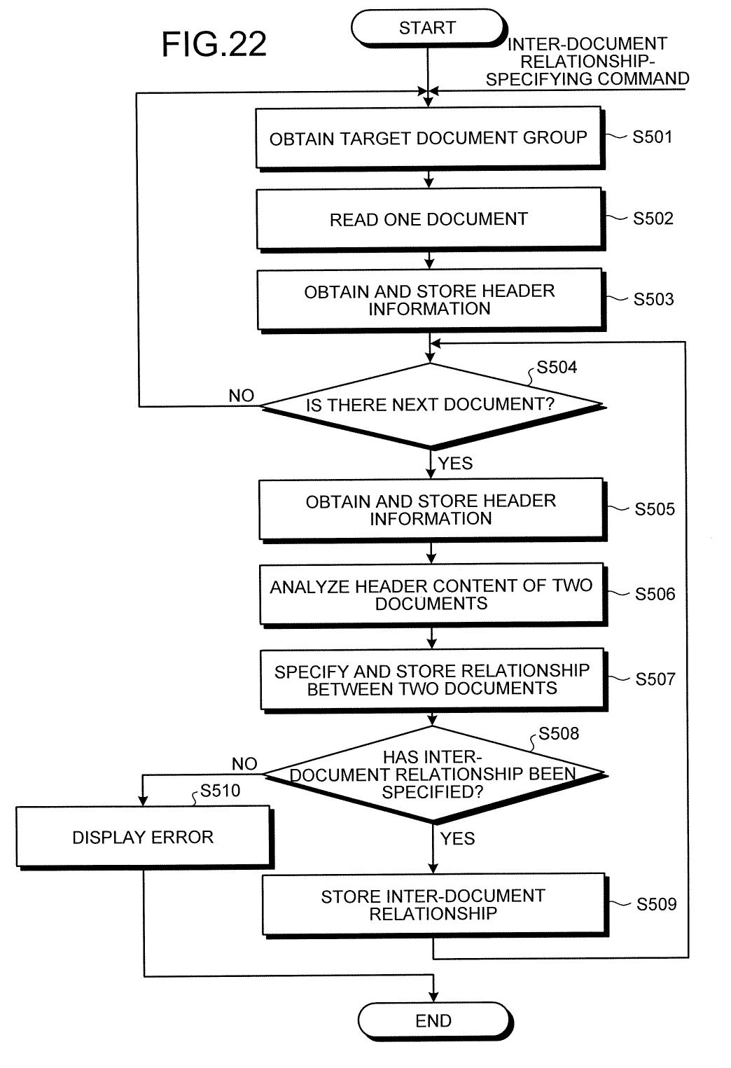

FIG. 22 is a flowchart of a document relationship-specifying process performed by the document-relationship specifying unit 31. Upon reception of an inter-document relationship-specifying command, the document-relationship specifying unit 31 obtains a target document group (step S501), and reads document 1 from the target document group (step S502). The document-relationship specifying unit 31 obtains the header information to store the header information in the storage unit 16 (step S503), and determines whether there is a next document (step S504). Upon determining that there is no next document (NO at step S504), the document-relationship specifying unit 31 waits for reception of an inter-document relationship-specifying command.

When determining that there is the next document (YES at step S504), the document-relationship specifying unit 31 obtains the header information of the next document to store the header information in the storage unit 16 (step S505). The document-relationship specifying unit 31 analyzes the stored header contents of the two documents (step S506) to specify the relationship between the two documents (step S507).

The document-relationship specifying unit 31 determines whether the document relationship can be specified (step S508). When determining that the document relationship can be specified (YES at step S508), the document-relationship specifying unit 31 stores the specified inter-document relationship in the storage unit 16 (step S509), and the process control returns to step S504. On the other hand, when the document-relationship specifying unit 31 cannot specify the inter-document relationship (NO at step S508), an error message is displayed on the monitor 18 via the display controller (step S510).

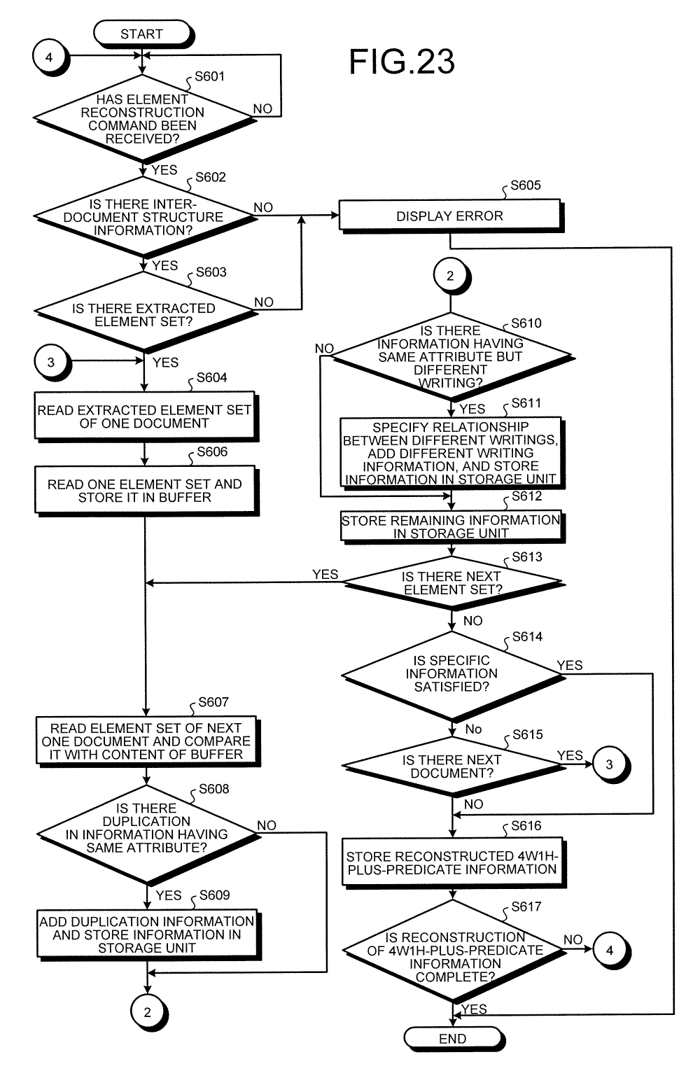

FIG. 23 is a flowchart of a process in which the element reconstructing unit 32 reconstructs the 4W1H-plus-predicate information. At the steps explained below, the operating body is the element reconstructing unit 32, unless otherwise specified. The element reconstructing unit 32 waits for reception of a reconstruction command of elements (4W1H-plus-predicate information). Upon reception of the element reconstruction command (YES at step S601), the element reconstructing unit 32 checks presence of the inter-document structure information of the target document group and 4W1H and predicate in the respective documents (steps S602 and 603). If there are both pieces of information (YES at steps S602 and 603), the element reconstructing unit 32 reads 4W1H and predicate in the first sentence in the first document (step S604) and stores 4W1H and predicate in the first buffer (step S606). If there is no 4W1H or predicate (NO at step S604, or NO at step S603), the element reconstructing unit 32 displays an error message on the monitor 18 via the display controller 17 (step S605), and the process control ends.

The element reconstructing unit 32 reads the next 4W1H and predicate in a comparison buffer to compare the read 4W1H and predicate with the information in the first buffer read at step S606 (step S607). For example, presence of duplication of respective 4W1H and predicates in the respective pieces of 4W1H attribute information, and presence of the information having the same attribute but different writing are compared. If there is a duplication, the element reconstructing unit 32 adds the duplication information to the respective pieces of information to store the information in the storage unit 16 (step S609).

Upon determining that there is the information having the same attribute but different writing (YES at step S610), the element reconstructing unit 32 specifies the relationship thereof by using the knowledge dictionary to add different writing information, and stores the information in the storage unit (step S611). The same attribute stands for belonging in the same W or H of 4W1H. The duplication information and the different writing information are expressed by, for example, a flag or a specific code. Upon completion of the comparison and specifying process of two sets of the 4W1H-plus-predicate information, the element reconstructing unit 32 stores the both pieces of 4W1H-plus-predicate information (step S612). If there is the next 4W1H and predicate (YES at step S613), the process control returns to step S607. The element reconstructing unit 32 shifts the 4W1H-plus-predicate information in the comparison buffer to the first buffer, reads the third 4W1H-plus-predicate information into the comparison buffer, and performs the comparison and specifying process again.

If determining that there is no next 4W1H and predicate (NO at step S613), the element reconstructing unit 32 determines whether the 4W1H and predicate group at this point in time satisfies the necessary 4W1H-plus-predicate information. The necessary 4W1H-plus-predicate information stands for information including all the 4W1H-plus-predicate information without missing anything (step S614).

When determining that the necessary 4W1H-plus-predicate information is satisfied (YES at step S614), the element reconstructing unit 32 selects the reconstructed 4W1H-plus-predicate information and stores the information (step S616), to finish the element reconstruction process (YES at step S617). If determining that there is the missing information (NO at step S614), and that there is the next document (YES at step S615), the process control returns to step S603. The element reconstructing unit 32 reads 4W1H and predicate in the next document, reads the first 4W1H and predicate into the comparison buffer to perform the comparison and specifying process, and repeats these processes until the necessary 4W1H-plus-predicate information is satisfied.

The 4W1H-plus-predicate information can be reconstructed not only from a plurality of pieces of document information but also from a plurality of sentences in one document information.

An example in which when the registered document group is the email document group, the information extracting apparatus 30 extracts the 4W1H-plus-predicate information to reconstruct the information based on the inter-document relationship information has been explained, however, the present invention can be applied to a case that the registered document group is other than the email document.

For example, when the registered document group is the bulletin board document group, the information extracting apparatus 30 can obtain the inter-document structure specific to the bulletin board document and the document peripheral information represented by the bibliographical information specific to the bulletin board document group, and supplement accompanying information of the event, which cannot be satisfied by information extraction from the text, to reconstruct the 4W1H-plus-predicate information.

When the registered document group is the chat document group, the information extracting apparatus 30 can obtain the inter-document structure specific to the chat document and the document peripheral information represented by the bibliographical information specific to the chat document group, and supplement the accompanying information of the event, which cannot be satisfied by information extraction from the text, to reconstruct the 4W1H-plus-predicate information.

The information extracting apparatus 30 can reconstruct the 4W1H-plus-predicate information by making a cited part in a text off the subject, without extracting extra 4W1H-plus-predicate information not directly related to the target document.

The information extracting apparatus 30 controls a useless increase of information due to duplication of the 4W1H and predicate elements, however, the information extracting apparatus 30 can release such control, as required.

When there is a plurality of pieces of 4W1H-plus-predicate information having the same attribute but different writing, the information extracting apparatus 30 can select only one 4W1H-plus-predicate information. For example, by setting “newest” or “detailed” in the setting information, the newest 4W1H-plus-predicate information or the most detailed 4W1H-plus-predicate information can be reconstructed. The user can optionally select such condition setting.

As described above, according to the third embodiment, the information extracting apparatus 30 specifies the inter-document relationship to reconstruct the 4W1H-plus-predicate information from respective pieces of extracted document information based on the specified inter-document relationship. Therefore, because the 4W1H-plus-predicate information is reconstructed from the 4W1H-plus-predicate information extracted from the respective pieces of document information based on the inter-document relationship, the information extracting apparatus 30 can extract the most suitable 4W1H-plus-predicate information in the inter-document relationship from a plurality of pieces of document information.

Accordingly, the accompanying information of the event in the text formed of a plurality of document groups can be accurately extracted without inputting a keyword by the user or defining information extraction beforehand. For example, when the document is accessed by using the data, the document content can be intuitively understood by referring to the information associated based on arranged events, rather than by using the conventional keyword extraction method in which the user refers to an extracted keyword to understand the document content, and therefore the document content can be understood more easily and accurately.

When the registered document group is the email document group, the inter-document structure specific to the email document and the document peripheral information represented by the bibliographical information specific to the email document can be obtained, and accompanying information of the event, which cannot be satisfied by information extraction from the text, can be supplemented more effectively, thereby improving the accuracy of information extraction.

When the registered document group is the bulletin board document group, the inter-document structure specific to the bulletin board document and the document peripheral information represented by the bibliographical information specific to the bulletin board document can be obtained, and the accompanying information of the event, which cannot be satisfied by information extraction from the text, can be supplemented more effectively, thereby improving the accuracy of information extraction.

When the registered document group is the chat document group, the inter-document structure specific to the chat document and the document peripheral information represented by the bibliographical information specific to the chat document can be obtained, and the accompanying information of the event, which cannot be satisfied by information extraction from the text, can be supplemented more effectively, thereby improving the accuracy of information extraction.

Because the cited part in a text is made off the subject, extra 4W1H-plus-predicate information not directly related to the target document need not be extracted. Accordingly, confusable information is removed, and processing efficiency of information extraction is improved, as compared to information extraction not adopting such a method, and therefore processing cost can be reduced.

Further, useless increase of information due to duplication of the 4W1H and predicate elements is controlled, and at the time of accessing the processing result by a system installing this method, the user can easily understand the processing result, and processing efficiency of information extraction is improved, thereby enabling a cost reduction of the processing.

Further, when there is a plurality of 4W1H-plus-predicate information having the same attribute but different writing, because only one 4W1H-plus-predicate information is selected, the user can understand the event in the document group without confusion. For example, by selecting one from an element [symbol] (the morning) and an element of [symbol] 0 [symbol] 12 [symbol] (10 to 12 AM), the information is simplified, and the user can easily understand the event. Alternatively, for example, by setting “newest” or “detailed” in the setting information, the user can optionally select the newest 4W1H-plus-predicate information or the most detailed 4W1H information. In other words, by inputting a condition, the user can extract the 4W1H-plus-predicate information most suitable for the input condition.

When the necessary information cannot be obtained from 4W1H and predicate in one document, because the necessary information can be supplemented from another document having the peripheral information of the document and a specific inter-document relationship with the document, the accompanying information of the event can be supplemented more effectively, thereby improving the accuracy of information extraction.

An information extracting apparatus according to a fourth embodiment of the present invention is different from that of the third embodiment in that a converter (not shown) converts the 4W1H-plus-predicate information associated and extracted by the element extracting unit 32 and the 4W1H-plus-predicate information reconstructed by the element reconstructing unit 32 into a computer readable and interpretable data representation. It is desired to display the data on the monitor 18 after converting the information into the computer readable and interpretable data representation. The converter can be arranged at the same position, for example, as in the second embodiment in the functional block diagram.

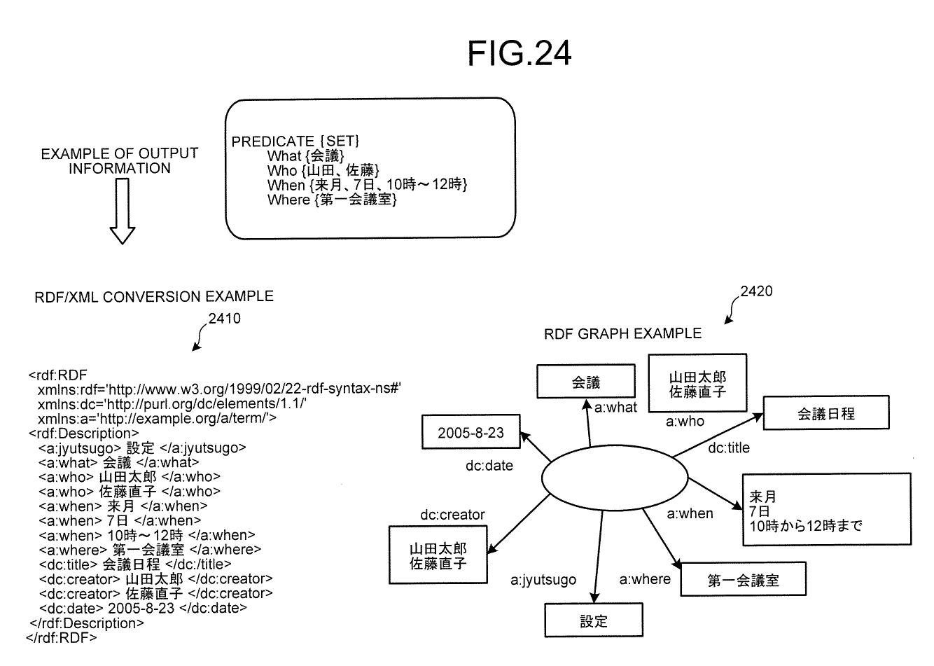

FIG. 24 is a schematic for explaining conversion examples in which the 4W1H-plus-predicate information is converted into an RDF syntax and an RDF graph by the converter of the information extracting apparatus according to a fourth embodiment. For example, URI, http://example.org/a/term defining the vocabulary of the 4W1H and predicate information is prepared and used together with the existing vocabulary (for example, Dublin Core). If there is an existing vocabulary matching the target document, a newly defined vocabulary need not be prepared. At the time of obtaining the 4W1H-plus-predicate information at the information extraction process in the present invention, the extraction information can be converted into, for example, RDF/XML together with the document information and stored. The information can be also converted into an RDF graph format in FIG. 24 to be presented to the user on the monitor 18.

An example in which the reconstructed 4W1H and predicate information is converted into the RDF syntax, stored, and output is explained with reference to FIGS. 17, 20, and 24. For example, it is assumed that the information extracting apparatus is started up and documents A to C in FIG. 17 are registered. At this time, the supplementary information by the context as shown in FIG. 20 is created simultaneously with registration of the documents. The document storage unit 16a stores therein the registered documents, and the information extracting apparatus performs the same document relationship-specifying process described above. The information extracting apparatus obtains the syntactic structure for the respective documents to extract 4W1H and predicate as explained above, obtains 4W1H and predicate in the respective documents as shown in FIG. 20, and stores the 4W1H and predicate information. As explained above, the information extracting apparatus supplements the information by the peripheral information of the document and the 4W1H and predicate information from respective documents, performs a selection process of the 4W1H-plus-predicate information, that is, the element reconstruction process to obtain final 4W1H and predicate.

In this example, for example, URI, http://example.org/a/term defining the vocabulary having the information of 4W1H and predicate as a property element is prepared beforehand, and a prefix thereof is expressed a: as shown, for example, in an RDF/XML conversion example in FIG. 24, to be used together with the existing vocabulary (for example, Dublin Core). If there is the existing vocabulary matching the target document, this vocabulary is used and a newly defined vocabulary need not be prepared.

The information is extracted in a unit of 4W1H and predicate from the extracted-information storage unit 16c. For example, when a selection result of 4W1H and predicate shown in FIG. 24 can be obtained, a blank node indicating a text content in the RDF syntax is described. A predicate [symbol] is described as a node element. What information [symbol] is described as a node element. Who information, [symbol] and [symbol] are described as a node element. When information, [symbol] , 7 [symbol] , and 10 [symbol] 12 [symbol] are described as a node element. Where information [symbol] is then described as a node element.

The information obtained from the bibliographical information is also described as a node element in addition to these pieces of information. As the information obtained from the supplementary information from the bibliographical information in FIGS. 19 and 20, title [symbol] , creators [symbol] and [symbol] , creation date “2005-8-23” of the document are described as a node element by using a prefix of Dublin Core.

These pieces of information are stored, and upon reception of an output command, the output process is executed. FIG. 24 is an RDF/XML conversion example 2410 of the extracted information, and an RDF/XML syntax or RDF graph format 2420 is shown as an output example.

Thus, according to the information extracting apparatus in the fourth embodiment, accompanying information of the event in the text can be converted to a machine processable data, even if the user does not have XML and RDF syntax knowledge. In other words, because accompanying information of the event in the text formed of a plurality of document groups can be converted to the RDF syntax automatically, the user can build a machine processable data model from the information-extracted data on a Web page, without using an RDF editor and requiring the special XML and RDF syntax knowledge.

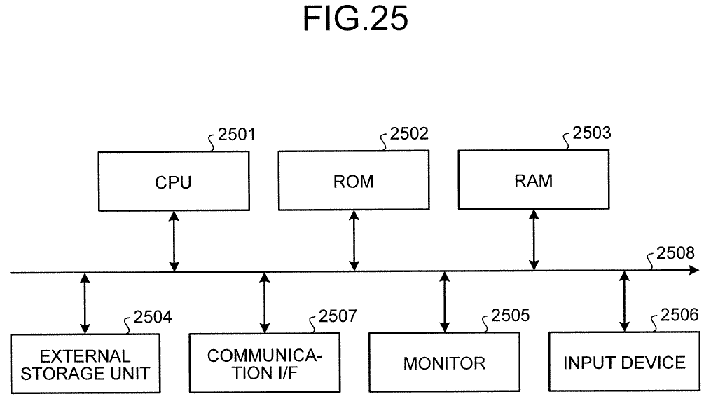

FIG. 25 is a block diagram of a hardware configuration of the information extracting apparatus according to the embodiments. The information extracting apparatus includes a controller such as a central processing unit (CPU) 2501, storage units such as a read only memory (ROM) 2502 and a random access memory (RAM) 2503, an external storage unit 2504 such as a hard disk drive (HDD) or a compact disk (CD) drive, a display unit 2505 such as a monitor, an input device such as a keyboard and a mouse, a communication I/F 2507, and a bus 2508 for connecting these units. The information extracting apparatus has a hardware configuration using a normal computer.

A computer program (hereinafter, “information extraction program”) executed on the information extracting apparatus is recorded on a computer readable recording medium such as a compact disc-read only memory (CD-ROM), a flexible disk (FD), a compact disc-recordable (CD-R), or a digital versatile disk (DVD) in an installable format file or an executable format file and provided.

The information extraction program can be provided as stored on a computer connected to a network such as the Internet and downloaded via the network. The information extraction program can be provided or distributed via the network such as the Internet. The extraction information program can be stored in the ROM or the like beforehand and provided.

The information extraction program includes modules that implement respective parts (the registering unit, the analyzer, the element extracting unit, the supplementary-information obtaining unit, the display controller, the document-relationship specifying unit, and the element reconstructing unit). As actual hardware, the CPU (processor) loads the information extraction program from the recording medium into a main memory to execute it. Accordingly, the respective parts such as the registering unit, the analyzer, the element extracting unit, the supplementary-information obtaining unit, the display controller, the document-relationship specifying unit, and the element reconstructing unit are implemented on the main memory.

According to an embodiment of the present invention, a syntactic structure of text information is analyzed, and the syntactic structure is used to extract five elements of When, Where, Who, What, and How, and predicate information from the text information. Thus, information related to each topic can be accurately extracted from text information as 4W1H-plus-predicate information without a keyword input by a user or predefined conditions for information extraction.

Moreover, a relationship between pieces of document information is specified, and 4W1H-plus-predicate information is reconstructed from 4W1H-plus-predicate information extracted from the pieces of document information based on the relationship. Thus, accompanying information such as schedule information can be extracted at a high speed from text formed of a plurality of pieces of document information.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information extracting apparatus comprising:
an analyzer that analyzes a syntactic structure of text information contained in first data; and
an extracting unit that extracts information on five elements, When, Where, Who, What and How, and a predicate from the text information based on the syntactic structure.

2. The information extracting apparatus according to claim 1, further comprising:
a storage unit that stores therein extracted information associated with the text information; and
a display unit that displays the extracted information associated with the text information.

3. The information extracting apparatus according to claim 1, further comprising:
a dictionary that contains at least one of a part of speech of a word and a combination of parts of speech of words in a clause, relationship information between a destination that the clause modifies and modification applied to the destination, and interpretation rules for determining which of the five elements and the predicate corresponds to the relationship information, wherein
the extracting unit extracts the information from the text information by using the dictionary.

4. The information extracting apparatus according to claim 3, wherein the relationship information is related to a range.

5. The information extracting apparatus according to claim 1, further comprising a supplementary-information obtaining unit that obtains attribute information accompanying the first data as supplementary information, wherein
the extracting unit supplements extracted information based on the supplementary information.

6. The information extracting apparatus according to claim 1, further comprising a supplementary-information obtaining unit that obtains another text information in the first data as supplementary information, wherein
the extracting unit supplements extracted information based on the supplementary information.

7. The information extracting apparatus according to claim 1, further comprising:
a supplementary-information obtaining unit that obtains peripheral information and information on five elements and a predicate from a second data as supplementary information; and
a relationship specifying unit that specifies a relationship between the first data and the second data;
a rearranging unit that rearranges the information on the five elements and the predicate, wherein
the extracting unit supplements extracted information based on the supplementary information, and
the rearranging unit rearranges the extracted information based on the relationship specified by the relationship specifying unit.

8. The information extracting apparatus according to claim 7, wherein the rearranging unit selects, when pieces of the supplementary information overlap by an amount equal to or greater than a predetermined threshold, one of the pieces of the supplementary information to rearrange the extracted information.

9. The information extracting apparatus according to claim 7, wherein the rearranging unit selects, when pieces of the supplementary information overlap by an amount equal to or greater than a predetermined threshold, one of the pieces of the supplementary information, and selects, when pieces of the information on the five elements and the predicate extracted from the first data and the second data overlap by an amount equal to or greater than a predetermined threshold, one of the piece of the information to rearrange the extracted information.

10. The information extracting apparatus according to claim 7, wherein the rearranging unit rearranges the extracted information based on the information on the five elements and the predicate extracted from second data.

11. An information extracting method comprising:
analyzing a syntactic structure of text information contained in first data; and
extracting information on five elements, When, Where, Who, What and How, and a predicate from the text information based on the syntactic structure.

12. The information extracting method according to claim 11, further comprising:
storing extracted information associated with the text information; and
displaying the extracted information associated with the text information.

13. The information extracting method according to claim 11, further comprising:
storing a dictionary that contains at least one of a part of speech of a word and a combination of parts of speech of words in a clause, relationship information between a destination that the clause modifies and modification applied to the destination, and interpretation rules for determining which of the five elements and the predicate corresponds to the relationship information, wherein
the extracting includes extracting the information from the text information by using the dictionary.

14. The information extracting method according to claim 13, wherein the relationship information is related to a range.

15. The information extracting method according to claim 11, further comprising obtaining attribute information accompanying the first data as supplementary information, wherein
the extracting includes supplementing extracted information based on the supplementary information.

16. The information extracting method according to claim 11, further comprising obtaining another text information in the first data as supplementary information, wherein
the extracting includes supplementing extracted information based on the supplementary information.

17. The information extracting method according to claim 11, further comprising:
obtaining peripheral information and information on five elements and a predicate from a second data as supplementary information; and
specifying a relationship between the first data and the second data;
rearranging the information on the five elements and the predicate, wherein
the extracting includes supplementing extracted information based on the supplementary information, and
the rearranging includes rearranging the extracted information based on the relationship specified at the specifying.

18. The information extracting method according to claim 17, wherein the rearranging includes selecting, when pieces of the supplementary information overlap by an amount equal to or greater than a predetermined threshold, one of the pieces of the supplementary information to rearrange the extracted information.

19. The information extracting method according to claim 17, wherein the rearranging includes selecting, when pieces of the supplementary information overlap by an amount equal to or greater than a predetermined threshold, one of the pieces of the supplementary information, and selects, when pieces of the information on the five elements and the predicate extracted from the first data and the second data overlap by an amount equal to or greater than a predetermined threshold, one of the piece of the information to rearrange the extracted information.

20. The information extracting method according to claim 17, wherein the rearranging includes rearranging the extracted information based on the information on the five
